(19) United States
(12) Patent Application Publication
(10) Pub. No.: US 2013/0188254 A1
(43) Pub. Date: Jul. 25, 2013

(54) THIN FILM OPTICAL FILTERS WITH AN INTEGRAL AIR LAYER

(71) Applicants: Li Li, Orleans (CA); Jerzy A. Dobrowolski, Ottawa (CA)

(72) Inventors: Li Li, Orleans (CA); Jerzy A. Dobrowolski, Ottawa (CA)

(73) Assignee: NATIONAL RESEARCH COUNCIL OF CANADA, Ottawa, ON (CA)

(21) Appl. No.: 13/062,266

(22) PCT Filed: Sep. 8, 2008
(86) PCT No.: PCT/CA2008/001562

§ 371 Date: May 11, 2011

(51) Int. Cl. G02B 5/28

(52) U.S. Cl. CPC G02B 5/284
USPC 359/589; 156/60; 156/330

(57) ABSTRACT

Novel thin film optical filters have an integral air layer. The frustrated total internal reflection (FTIR) phenomenon, combined with thin film interference, is used to effectively control the polarization properties of thin film coatings operating at oblique angles. The invention is applicable to high-performance thin film polarizing beam-splitters, non-polarizing beam-splitters, non-polarizing cut-off filters and non-polarizing band-pass filters, and any other thin film coatings that require the control of polarization effect. The low index layer offers an improvement in performance and the simplification of the thin film optical filter coating designs by reducing the total number of layers and the total layer thicknesses to minimize the angles of incidence and the size of the filter substrates, thereby minimizing the contact area and hence reducing the manufacturing costs.

### FIELD OF THE INVENTION

This invention relates to the field of optical filters, and in particular optical filters employing thin film interference and frustrated total internal reflection (FTIR).

### BACKGROUND OF THE INVENTION

Thin film optical filters are often used in applications that require light incident at the filter surfaces at non-normal or oblique angles of incidence in order to generate two beams: a reflected beam and a transmitted beam. Such optical filters include thin film polarizing beam-splitters, non-polarizing beam-splitters, long-wavelength and short-wavelength cut-off filters, bandpass filters, etc. Often these thin film optical filters consist of multiple layers between two solid glass substrates or prisms. One arising issue with optical filters used at oblique angles of incidence is the polarization effect for s- and p-polarized light due to their different optical admittances at oblique angles. This polarization effect is manifested as different filter properties for s- and p-polarized light, such as different reflectance, transmittance, or phase changes on reflection or transmission. For polarizing beam-splitters, the polarization effect needs to be enhanced in order to reflect light in s- or p-polarization and transmit light in p- or s-polarization. For many other optical filters such as non-polarizing beam-splitters, cut-off filters and bandpass filters, the polarization effect is not desirable and must be minimized.

Using thin film interference effect alone to either enhance or minimize polarization effect in these optical filters often does not produce satisfactory results. However, it has been demonstrated that the phenomenon of frustrated total internal reflection can be combined with thin film interference to successfully control the polarization effect in polarizing and non-polarizing thin film beam-splitters. In particular, high-performance thin film polarizing beam-splitters operating at angles greater than critical angle and having all solid films were disclosed in U.S. Pat. No. 5,912,762 and in the paper by Li Li and J. A. Dobrowolski, “High-performance thin-film polarizing beam splitter operating at angles greater than the critical angle,” Appl. Opt. Vol. 39, pp 2754-2771 (2000). In addition, in the paper by Li Li “Design of thin film optical coatings with frustrated total internal reflection”, Optics and Photonics News, September 2003, pp 24-30 (2003), it also has been shown that the FTIR effect can be used to minimize polarization effects in non-polarizing beam-splitters having solid layers as described.

Traditional FTIR filters consist of solid thin film layers that are made of solid materials and are deposited by physical or chemical vapour deposition techniques. The use of FTIR effect requires that the incident angles inside the lowest refractive index n_{L} layers in the filter coatings be greater than that of the critical angle θ_{C}, which is defined as:

$${θ}_{C} = arcsin ( \frac{{n}_{L}}{{n}_{0}} ) , \qquad ( 1 )$$

where n₀ is the refractive index of the substrate.

There are several problems with using the FTIR effect in thin film optical filters having solid layers. First, because the selection of low index coating materials is limited and the refractive index values are not as low as one would prefer, usually 1.38 for MgF₂ and 1.45 for SiO₂, which leads to a very large critical angle θ_{C}. For example, when n₀=1.52, n_{L}=1.45, θ_{C}=72.5°. The large θ_{C} will result in large working angles for the thin film optical filters, which in turn results in large size filters. Large size optical filters are not desirable for many applications. Second, although the critical angle can be reduced by using high index substrates (for example, n₀>1.60), more, complicated or expensive optical bonding technique have to be used to cement the two substrates together.

It is generally very difficult to bring two coated high refractive index prisms into good contact. Index matching optical cements, which are commonly used in the optics industry, are not suitable for this purpose because stable and highly transparent (transmittance>95%) optical cement with a refractive index greater that 1.60 is not available. Refractive index-matching liquids are also not suitable because they are usually not stable and require proper sealing and thickness control. Furthermore refractive index-matching liquids with refractive indices greater than 1.80 usually contain very toxic materials, such as arsenic. In addition, for the infrared spectral region, there are practically no optical cements transparent for the infrared spectral region from 2 μm to 30 μm. Thus, the only suitable optical bonding technique is very expensive optical contacting.

Optical contacting is a well-established technique that has been used in optical shops for many years. The principle of optical contacting is that if the two contacting surfaces are flat and smooth enough, a van der Waals bond (sometimes with assistance from chemical bonding) will hold them together. To form a strong van der Waals bond, the surfaces of the substrates have to be polished very smooth with a flatness to be at least λ/10, where λ is the wavelength of light used to measure the flatness of the surfaces and λ is usually in the visible and about 630 nm. This strict flatness requirement increases the manufacturing cost. Poor coating quality such as roughness can further reduce the success rates of optical contacting. The difficulty of achieving a good optical contact is directly proportional to the area of the surfaces to be contacted. The larger the component surfaces, the more difficult it is to make their surfaces sufficiently flat and smooth for optical contact. In addition, for optical filters in the infrared spectral region, because the optical filters are much thicker compared to the visible spectral region, the filter coatings are usually deposited by a much faster evaporation process that inherently produces rough and porous films, making optical contacting even more difficult.

The use of an air layer or gap has been described in tunable Fabry-Perot filters. In these filters, the air gap allows the layer thickness to be varied in order to tune the filter properties, for example, to change the pass band wavelength. In such tunable filters, the low refractive index of the tuning air layer is not of any significance. Another use of an air gap within thin film systems occurred the late 1960-ties, in resonant reflectors, in which thin, self-supporting silica or sapphire plates were spaced with air to form reflectors that survived high power laser irradiation. In both instances light is incident at normal angle of incidence (0°) and prisms are not used and not FTIR effect occurs. Moreover, in each case there was a specific reason to employ an air gap specific to the particular product.

The use of an air gap as a medium in birefringent polarizers is known. It has also been recently proposed in the US patent Application Nos. US20030112510 and US20060098283 to form metal grid polarizing beam-splitters. These polarizers and polarizing beam-splitters are based on different physical principles than that of the present invention. No light interference or frustrated total internal reflection is employed in these devices.

### SUMMARY OF THE INVENTION

According to one aspect of the present invention there is provided an optical device comprising an optical device comprising: a pair of transparent substrate prisms having opposing faces bonded together at an interface; a thin film interference structure between said pair of transparent substrate prisms; and a spacer layer located between said opposing faces, said spacer layer separating said transparent substrates to form a cavity containing low refractive index layer comprising a non-reactive gas or vacuum; and wherein said low refractive index layer in said cavity acts as an interference layer forming an integral part of said thin film structure, and wherein said thin film structure is operable to permit thin film interference coupled with frustrated total internal reflection inside said low index layer at certain angles of incidence.

The thin film interference structure will normally consist of a plurality of coatings deposited on at least one of the opposing faces, but in the extreme case it would be possible to construct a thin film interference structure consisting only of one coating and the low refractive index layer.

It will be understood that the thickness of the layers in the “thin” film structure is commensurate with the wavelength of the light for which the device is designed to operated so that thin film interference effects occur.

The embodiments of the invention effectively control the polarization effects with an integral air layer in thin film optical filters that operate at oblique angles greater than the critical angle. The air layer which is defined by a spacer layer permits the easy fabrication of high-performance thin film optical filters with reduced cost. In addition, compared to traditional thin film optical filter having all solid films, these embodiments have much improved performances, or smaller prism size because the angles of incidence can be reduced with the use of low index air layer, or reduced total number of layers or layer thickness, or all of the above.

The use of an air gap as a medium as known in the prior art is very different from using an air gap, or more precisely air layer, as an integral part of thin film interference filters in the present invention. First of all, unlike the invention, such an air gap is generally very thick compared to the wavelength of the light and is treated as a medium rather than an interference thin film. Its thickness does not affect the performance of the device and because it is so thick that no light interference occurs between the light reflected from the two air substrate interfaces because the optical path length is longer than the coherence length of most light sources. Second, the incident angle for the desired polarization is smaller than the critical angle, so no frustrated total internal reflection or total internal reflection occurs inside the air gap. If the incident angle on these devices were greater than the critical angle, all light would be reflected, no light would be transmitted and the device would not work at all. In the present invention, the cavity layer is treated as an integral part of the thin film interference-frustrated total internal reflection structure, and has a layer thickness commensurate with this role.

It will be understood that references to light and “optical” in this specification are not limited to the visible region. The invention is applicable to all wavelengths, for example, UV, visible, infrared and millimeter wavelength region susceptible to filtering and combining/splitting by the prism devices described.

According to another aspect of the invention there is provided a method of making an optical device comprising: providing a pair of transparent substrate prisms having opposing faces; forming a thin film interference structure between said pair of transparent substrates configured to subject light incident on one of said substrates at certain angles of incidence to thin film interference coupled with frustrated total internal reflection; and bonding opposing faces together through a spacer layer, said spacer layer separating said transparent substrates to form a low refractive index cavity layer that acts as an interference layer forming an integral part of said thin film interference structure.

### BRIEF DESCRIPTION OF THE DRAWINGS

The invention will now be described in more detail, by way of example only, with reference to the accompanying drawings, in which:

FIG. 1 shows a thin film optical filter having an integral air layer;

FIG. 2 is an expanded view of the thin film optical filter structure;

FIG. 3 shows a thin film optical filter having an integral air layer with different spacer patterns;

FIG. 4 shows a thin film optical filter having an integral air layer with additional side panels;

FIG. 5 shows a simple thin film optical filter S1 having two high index substrates and a single air layer;

FIG. 6 shows the calculated transmittance of s- and p-polarized light with angle of incidence for the above filter S1 with n₀=1.75, n₁=1.0 and a layer thickness d₁=50 nm at wavelength λ=550 nm;

FIG. 7 shows the calculated transmittance of s- and p-polarized light with angle of incidence for the above filter S1 with n₀=1.75, n₁=1.0 and a layer thickness d₁=100 nm at wavelength λ=550 nm;

FIG. 8 shows the calculated transmittance of s- and p-polarized light with angle of incidence for the above filter S1 with n₀=1.75, n₁=1.0 and a layer thickness d₁=200 nm at wavelength λ=550 nm;

FIG. 9 shows the calculated transmittance of s- and p-polarized light with angle of incidence for the above filter S1 with n₀=1.75, n₁=1.0 and a layer thickness d₁=500 nm at wavelength λ=550 nm;

FIG. 10 shows the calculated transmittance of s- and p-polarized light with angle of incidence for the above filter S1 with n₀=1.75, n₁=1.0 and a layer thickness d₁=1000 nm at wavelength λ=550 nm for s- and p-polarized light;

FIG. 11 shows the calculated transmittance of s- and p-polarized light with angle of incidence for a filter similar to S1 but with n₀=1.75, n₁=1.0 the air layer is treated as a medium rather than a thin film at wavelength λ=550 nm;

FIG. 12 shows the calculated transmittance of s- and p-polarized light with angle of incidence for a simple optical filter similar to S1 but having n₀=1.75, n₁=1.45 and d₁=50 nm with a layer medium at wavelength λ=550 nm;

FIG. 13 shows the calculated transmittance of s- and p-polarized light with angle of incidence for a simple optical filter similar to S1 but having n₀=1.75, n₁=1.45 and d₁=100 nm with a layer medium at wavelength λ=550 nm for s- and p-polarized light;

FIG. 14A shows the calculated reflectance Rs of a thin film polarizing beam-splitter PBS1 without an air layer operating at angles greater than the critical angle;

FIG. 14B shows the calculated reflectance Rp of a thin film polarizing beam-splitter PBS1 without an air layer operating at angles greater than the critical angle;

FIG. 14C shows the calculated transmittance Ts of a thin film polarizing beam-splitter PBS1 without an air layer operating at angles greater than the critical angle;

FIG. 14D shows the calculated transmittance Tp of a thin film polarizing beam-splitter PBS1 without an air layer operating at angles greater than the critical angle;

FIG. 14E shows the calculated reflectance Rs of a thin film polarizing beam-splitter PBS2 with an air layer operating at angles greater than the critical angle in accordance with the present invention;

FIG. 14F shows the calculated reflectance Rp of a thin film polarizing beam-splitter PBS2 with an air layer operating at angles greater than the critical angle in accordance with the present invention;

FIG. 14G shows the calculated transmittance Ts of a thin film polarizing beam-splitter PBS2 with an air layer operating at angles greater than the critical angle in accordance with the present invention;

FIG. 14H shows the calculated transmittance Tp of a thin film polarizing beam-splitter PBS2 with an air layer operating at angles greater than the critical angle in accordance with the present invention;

FIG. 14I shows the calculated reflectance Rs of a thin film polarizing beam-splitter PBS3 with an air layer operating at angles greater than the critical angle in accordance with the present invention;

FIG. 14J shows the calculated reflectance Rp of a thin film polarizing beam-splitter PBS3 with an air layer operating at angles greater than the critical angle in accordance with the present invention;

FIG. 14K shows the calculated transmittance Ts of a thin film polarizing beam-splitter PBS3 with an air layer operating at angles greater than the critical angle in accordance with the present invention;

FIG. 14L shows the calculated transmittance Tp of a thin film polarizing beam-splitter PBS3 with an air layer operating at angles greater than the critical angle in accordance with the present invention;

FIG. 15A shows the calculated transmittance of a non-polarizing beam-splitter NPBS1 without an air layer operating at angles greater than the critical angle;

FIG. 15B shows the calculated transmittance of a non-polarizing beam-splitter NPBS2 with an air layer operating at angles greater than the critical angle in accordance with the present invention;

FIG. 15C shows the calculated transmittance of a non-polarizing beam-splitter NPBS3 with an air layer operating at angles greater than the critical angle in accordance with the present invention;

FIG. 16A shows the calculated transmittance of a thin film shortwave pass filter NPSP1 without an air layer operating at angles greater than the critical angle;

FIG. 16B shows the calculated transmittance performance of a thin film shortwave pass filter NPSP2 with an air layer operating at angles greater than the critical angle in accordance with the present invention;

FIG. 17A shows the calculated performance of a thin film bandpass filter NPBP1 without an air layer operating at angles greater than the critical angle;

FIG. 17B shows the calculated performance of a thin film bandpass filter NPBP2 with an air layer operating at angles greater than the critical angle;

FIG. 18A shows the calculated performance of a thin film cut-off filter NPCF1 without an air layer operating at angles greater than the critical angle; and

FIG. 18B shows the calculated performance of a thin film cut-off filter NPCF2 with an air layer operating at angles greater than the critical angle.

### DETAILED DESCRIPTION OF THE PREFERRED EMBODIMENTS

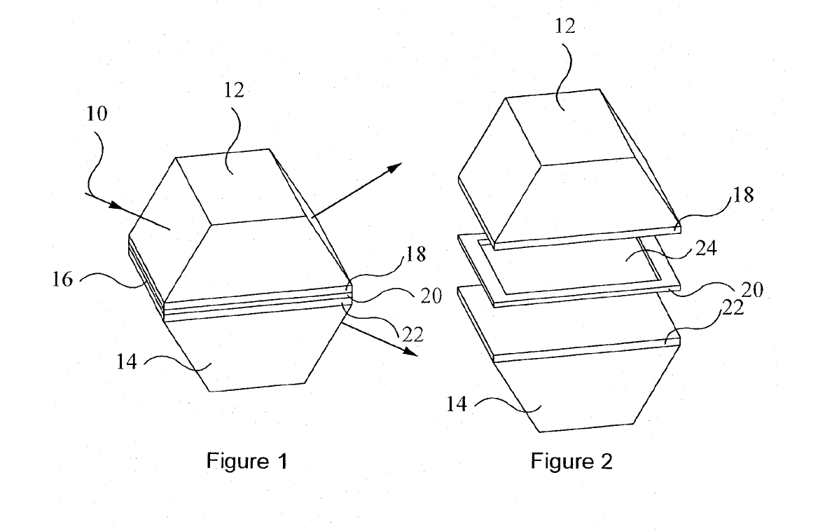

The layouts the novel thin film optical filters with an integral air layer will be explained with reference to FIGS. 1 to 4. When incident light 10 is incident at the thin film coating surface at an oblique angle, some of the incident light will be reflected and some will be transmitted according to the filter requirements.

As shown in FIGS. 1 to 4, the thin film optical filter has a transparent top-prism 12 and a transparent bottom-prism 14 having a refractive index n₀ and a thin film coating structure 16 at the interface between the two prisms. The thin film coating structure 16 consists of a top coating 18, a spacer layer 20 and an optional bottom coating 22. The spacer layer 20 bounds a cavity containing an air layer 24, also referred to herein as the cavity layer. The top- and bottom-coatings 18, 22 together with the air layer 24 form a complete thin film interference coating structure. The air layer 24 acts as an interference layer within the complete thin film structure. The spacer layer can be made from the same material as the coatings, and may, for example, be selected from the group consisting of: ZnS, Ge, Si, MgO, SiO₂, TiO₂, Ta₂O₅, Nb₂O₅, and Al₂O₃.

Both the top- and bottom-coatings can have multiple layers made of different coating materials. The incident angle inside the air layer 24 within the spacer 20 is selected to be larger than the critical angle for most of incident angles. Thus, frustrated total internal reflection can occur inside the air layer and evanescent waves can penetrate to the bottom-coating 22. The FTIR effect combined with thin film interference effect can then be used to design filters with much better control polarization effect.

The thickness of the cavity layer depends on many factors. For example, different filter designs would require different thicknesses. The thickness of the cavity layer also changes when the working incident angle changes. Furthermore, the thickness of the cavity layer depends on the wavelength. For example, in a special case, the cavity thickness of a filter design in the UV at 250 nm wavelength may be 50 nm; for a similar filter design in a different spectral region, the thickness would be 110 nm in the visible at 550 nm, 1 μm in the mid IR at 5 μm, 3 μm in the far IR 15.0 μm, or 200 μm in the millimeter wavelength region at 1 mm. The present invention is applicable to all appropriate wavelength regions, not only the visible and IR as shown in the examples.

The thickness of the cavity layer should satisfy the frustrated total internal reflection condition; in other words, part of the light must be transmitted through the cavity layer at the designed wavelength region and working angles (for example, the cavity layer must allow at least 1% of light incident upon it to be transmitted), otherwise total internal reflection would occur and no interference effect will take place.

The cavity bounded by the spacer 20 does not have to be filled with air. Air is the default filler because no additional work is required. However, the cavity can contain a vacuum (the refractive index of vacuum is the same as air n=1.0) or any non-reactive gas as long as the refractive index of the gas is low compared to solid low index films. The lower the refractive index the better because lowering the refractive index reduces the critical angle. Most gases have a refractive index close to 1. The gas should also not have significant absorption (some gas absorbs light in part of the spectrum) in the designed wavelength and should not be corrosive.

The top- and bottom coatings 18, 22 can be deposited onto their associated prism substrates by any suitable thin film deposition processes, such as e-beam-evaporation, sputtering and ion-assisted deposition. In some coating designs, the thin film optical filter has symmetrical layer structures, thus the top- and bottom-coatings are identical and can be deposited in one coating run. In other cases, the top- and bottom-coatings are different and have to be deposited in separate coating runs. In addition, for some designs, only the top-coating or the bottom-coating is required.

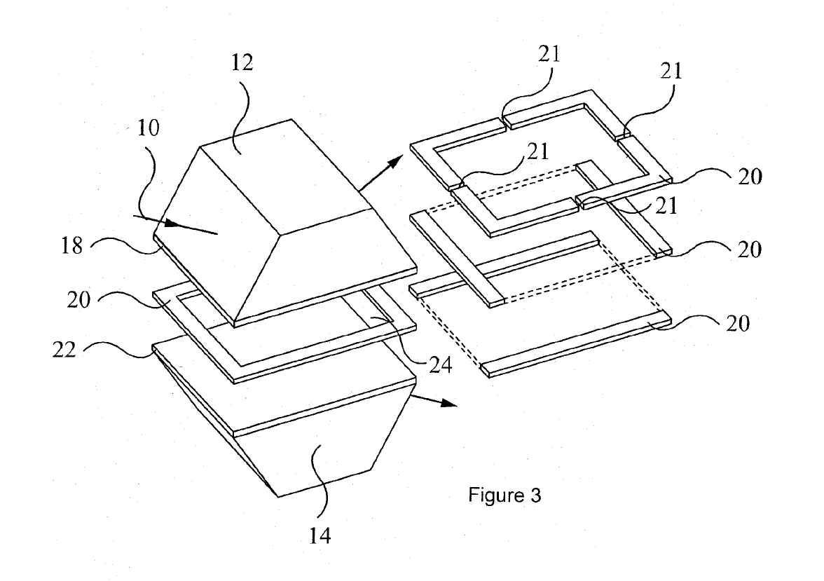

FIG. 2 is an expanded view of the thin film optical filter with the integral air layer 24 formed within the spacer 20. The spacer 20 is used to precisely control the air layer thickness and it only covers the small area of the substrates, such as the four edges of the prism substrate as shown in FIG. 2. Alternatively, it can only cover parallel edges as shown in FIG. 3, or any other suitable patterns such those shown in FIG. 3. Slits 21 can be provided to admit air to, or release air from, the cavity.

Any spacer layer 20 that can have a precise thickness and can be bonded to the substrates accurately can be used to define the air layer thickness such as a precisely cleaved mica film. Preferably, the spacer layer 20 is deposited by a thin film deposition process similar to the process used for the depositing the top- and bottom-coatings because such a process provides accurate thickness control. The spacer layer can be deposited on one of the transparent substrate, or on both. The latter case is more suitable to symmetrical thin film coating designs of the thin film optical filters in the present invention.

To obtain the patterns for the spacer, shadow masks can be used during the deposition of the spacer layer 20. The spacer layer 20 can be deposited directed onto the coated prism substrates or deposited onto smooth bare prism substrates. The advantage of depositing the spacer layer directly onto the coated prisms is that the required spacer thickness is much smaller and thus require much less time to deposit. However, the top- and bottom-coatings can introduce roughness, which is not desirable for later bonding the coated substrates, especially when e-beam evaporation process is used that inherently produce rough and porous films. Thus, depositing the spacer layer directed onto bare substrates using a different deposition process that produces smooth and dense films will prevent the coating roughness from impact on subsequent bonding.

To manufacture the thin film optical filter, the two prism substrates 12, 14, either both coated with coatings or only one with coatings depending on the filter requirements, are then brought to optical contact but only in the small area defined by the spacer 20. Since the spacer area is much smaller than the actually coated coating surface, it will have a much higher success rate of achieving good bonding between the coated prism substrates, hence minimize the manufacturing cost.

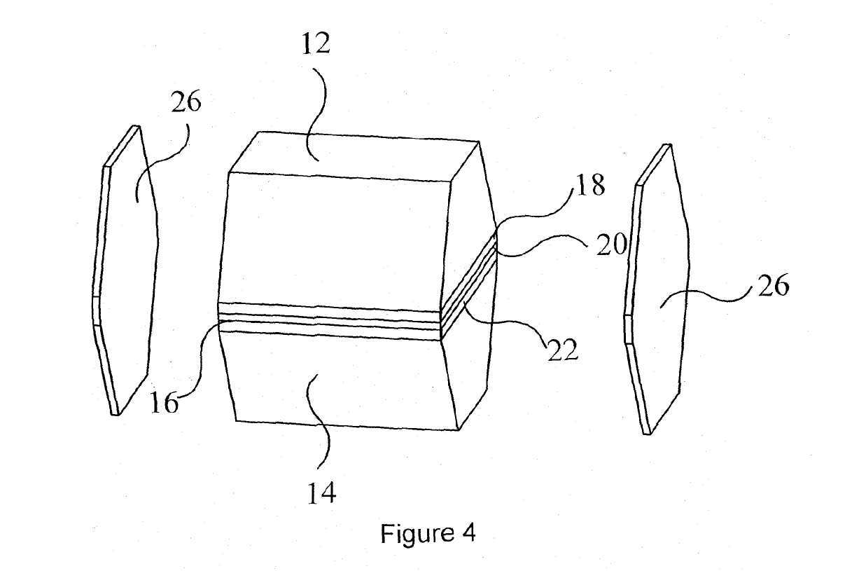

To make the optical contact more secure, two optional thin plates 26, preferably made of the same material as the prisms, can be attached to the sides of the contacted assembly by glue or epoxy, as shown in FIG. 4. Since these sides of the prism do not transmit light, the optical properties of the glue or epoxy are not important. The finished prism assemblies are expected to be very solid. Alternatively, a bead of epoxy applied to the exposed edge of the optical contact may be deemed to be enough to provide sufficient strength. Many different shapes of prisms can be used.

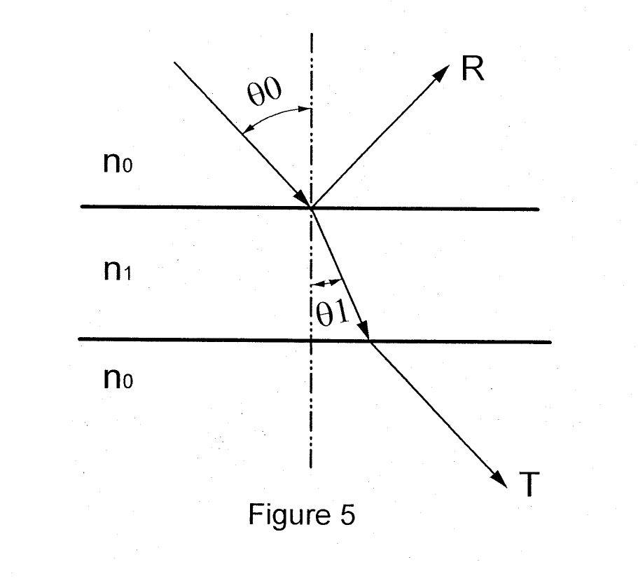

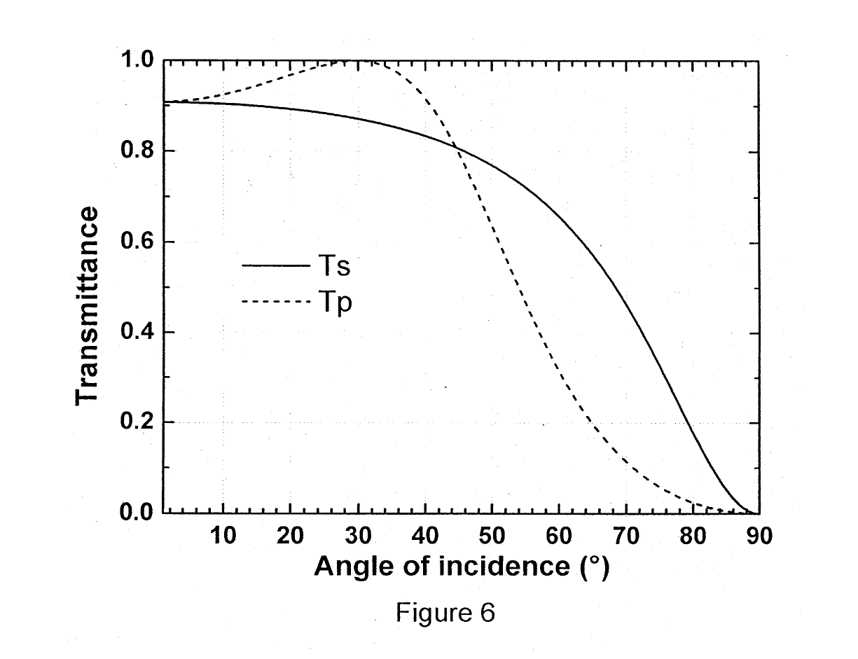

To demonstrate how the low refractive index air layer can be used to better control polarizing effect in thin film optical filter coatings, we will use, as an example, a simple optical filter S1 consisting of two high index substrates with n₀=1.75 and only a single air layer with the refractive index n₁=1 and a thickness equal to 50 nm as shown in FIG. 5. The critical angle is θ_{C}=34.85°. FIG. 6 shows the calculated transmittance varied with angle of incidence at wavelength λ=550 nm for s- and p-polarized light, respectively. Because the air layer is relative thin, even with an incident angle greater than the critical angle, part of light is still transmitted through the filter structure due to the penetration of the evanescent wave into the bottom prism substrate. This phenomenon is called frustrated total internal reflection. In addition, light rays reflected from and transmitted through the interfaces between the top prism/air layer and the bottom prism/air will with interfere with each other. Thus, the transmittance or reflectance of the optical filter is the result of the combined FTIR and interference effects.

As shown in FIG. 6, the transmittances of s- and p-polarized light are much closer to each other at small angles of incidence. When the incident angle increases, the transmittance of s-polarized decreases instead. However, the transmittance of p-polarized light will increase to a maximum value when the incident angle is equal to the Brewster angle and then it decreases at a faster rate with incident angles than the transmittance of s-polarized light. The transmittance curves of s- and p-polarized light intersect at an angle θ_{N}. At this incident angle, there is no difference between the transmittance for s- and p-polarized light; this incident angle is greater than the critical angle and is herein referred to as the non-polarizing angle. This curve explains why the frustrated total internal reflection can be combined with thin film interference effect to design non-polarizing optical filters such as non-polarizing beam-splitters, cut-off filters, bandpass filters in the present invention. In addition, when the incident angle further increases, the difference between the transmittances of s- and p-polarized light becomes larger, this enhanced polarizing effect also helps to design polarizing beam-splitters that transmits s-polarized light and reflects p-polarized light. Both the non-polarizing effect and polarizing effect also applies to the design of optical filters having multiple layers including low index air layer.

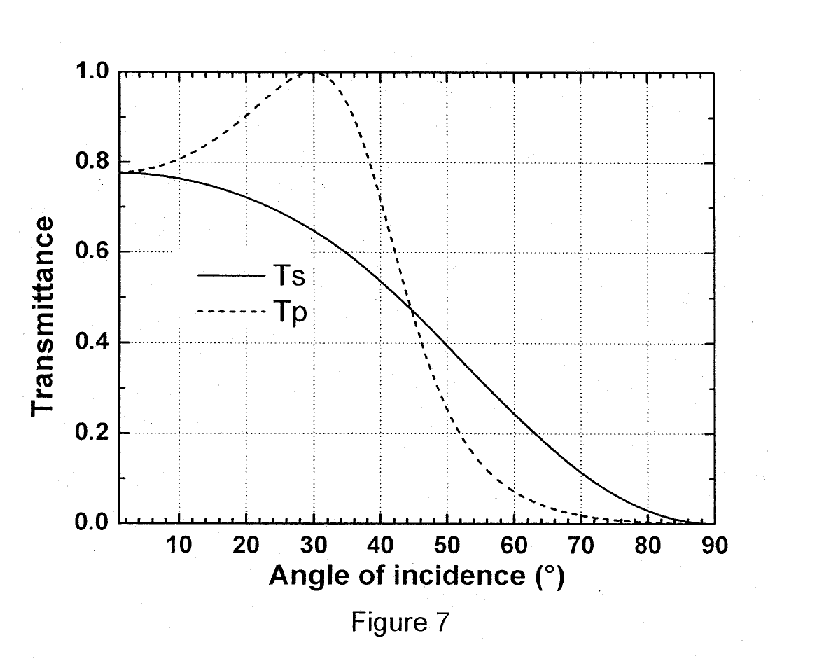

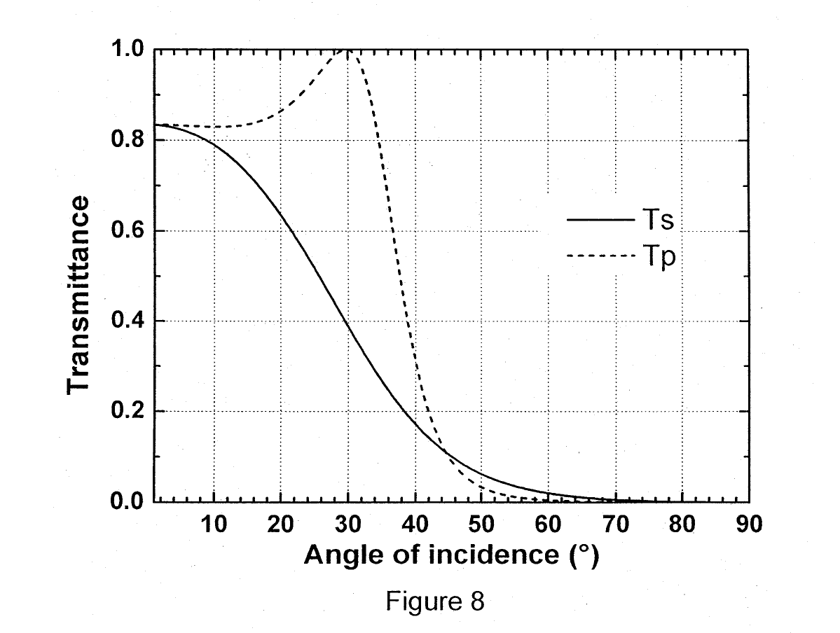

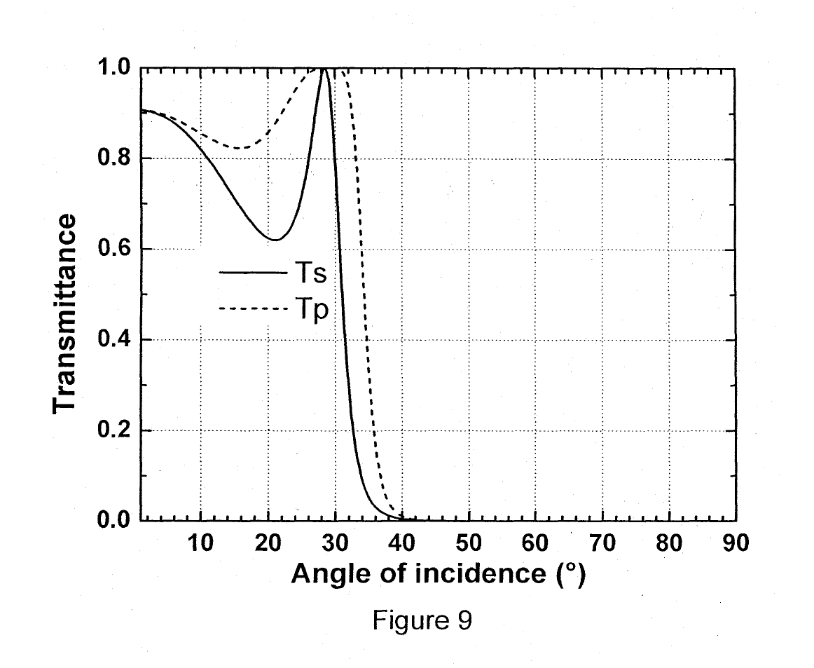

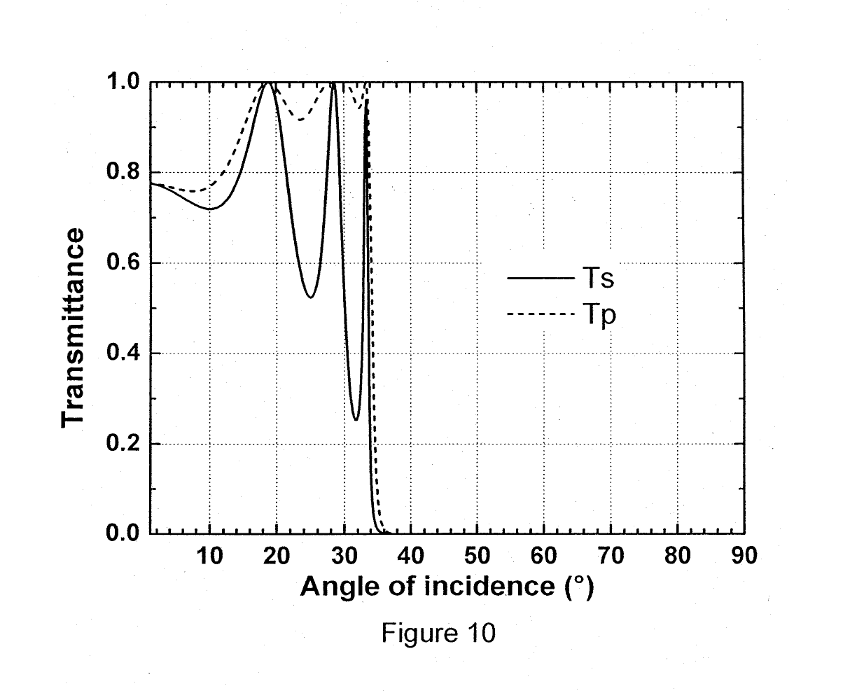

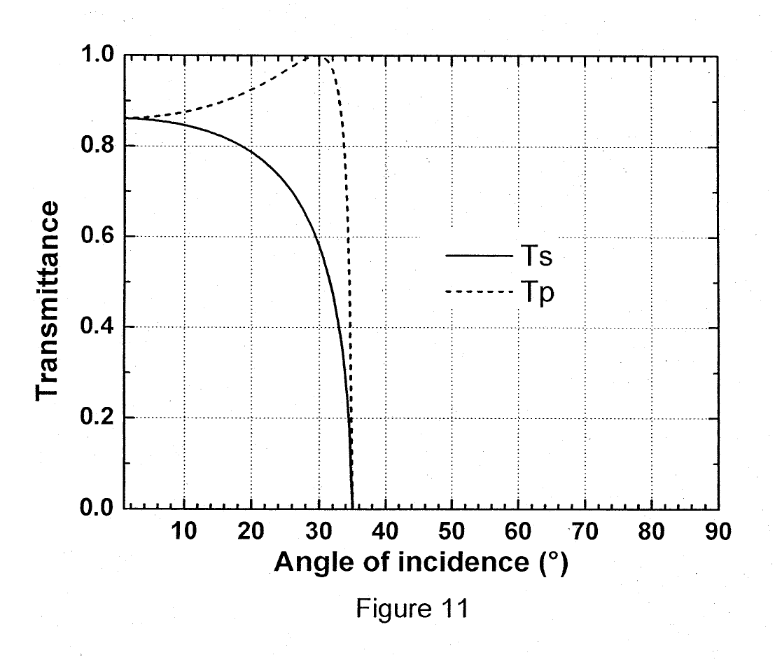

FIGS. 7 to 11 show how the transmittance for s- and p-polarized light changes when the thickness of the air layer in the filter S1 is increased to 100 nm, 200 nm, 500 nm and 1,000 nm, respectively. When the thickness is of the air layer is sufficient thick, for incident angles above the critical angle, no light can penetrate to the bottom prism and all incident light will be totally reflected—this is the total internal reflection, not frustrated total internal reflection. The thin film optical filter in the present invention operates in the frustrated total reflection region. When the air gap is thick and no frustrated total internal reflection and no light interference occur at the interfaces of the air gap, the air gap acts essentially as a medium. Further increasing the thickness of air medium does not affect the transmittance or reflectance. FIG. 11 shows the transmittance and reflectance of a structure similar to the filters shown in FIGS. 6-10 but the air layer is treated as a medium and as can be seen that no light transmits through the structure when the incident angle is greater than the critical angle and all light is totally reflected, unlike the air layers used in the present invention.

By contrast in birefringent polarizers with air gaps or the metal grid PBS with an air gap, such as described in US Patent Application No. US20060098283, the air gap is very thick and is essentially acting as a medium. Thus, the incident angles in these devices must be smaller than the critical angle in the desired polarization, otherwise total internal reflection will occur and no light will be transmitted through the device at all and hence the device will not work as intended as demonstrated in FIG. 11. In addition, when the air gap is so thick, the optical path will likely be longer than the coherent length of the light source, so no light interference will occur between light reflected from the two interfaces. The intensity of the reflected or transmitted light is simply a summation of the intensity of the transmitted or reflected beams.

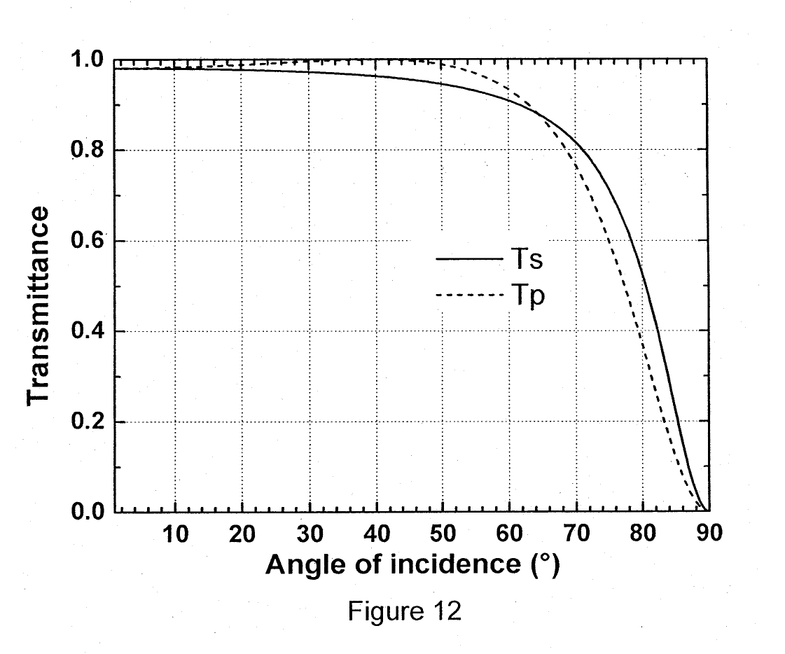

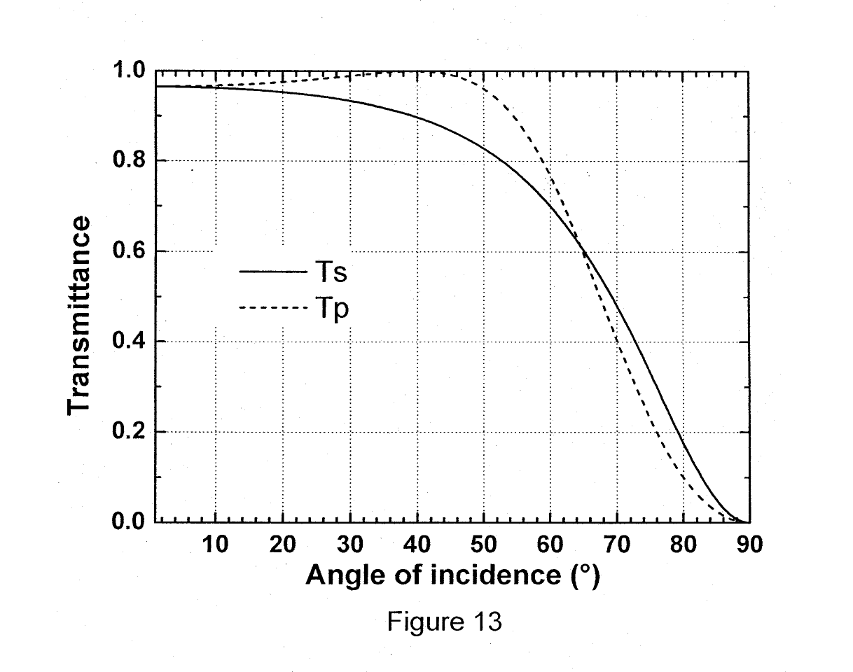

FIG. 12 shows the transmittance of another simple structure consisting of two high index prisms with n₀=1.75 and a single SiO₂ layer with n₁=1.45. The calculated critical angle is 55.95°, more than 20° higher than that of the air layer in FIGS. 6-10, so is the non-polarizing angle. The SiO₂ layer thickness is also 50 nm. As it can be seen, the difference between s- and p-polarized light is rather small, compared to FIG. 6 with the same layer thickness. To achieve a similar transmittance difference between the s- and p-polarized light, the thickness of the SiO₂ has to be increased as shown in FIG. 13 in which the layer thickness is 100 nm. This observation applies to optical filters with multiple layers including low refractive index layers as well. Thus, for enhancing the polarizing effect that is required for the designs of polarizing beam-splitters, much thicker films would have to be used or more layers would have to be used in the case with all-solid films. Hence, it clearly demonstrates the advantages of the use of air layer in the thin film optical filters in the present invention. It reduces incident angles, thus prism size; second, it reduces the layer thickness or the total number of layers, or both. All cases help minimize the manufacturing costs. Besides the advantages of using FTIR with the low index air layers, many optical coatings can also benefit greatly from the use of pairs of coating materials having high refractive index ratios. The end results are better performance and also the reduced number of layers and total layer thickness. Clearly, these benefits of using low refractive index layer in optical filters can not be realized by using all-solid layer structures.

### Examples of Thin Film Optical Filters Having an Integral Air Layer

To further demonstrate the performance of the new thin film optical filters, some specific non-limiting examples will be given.

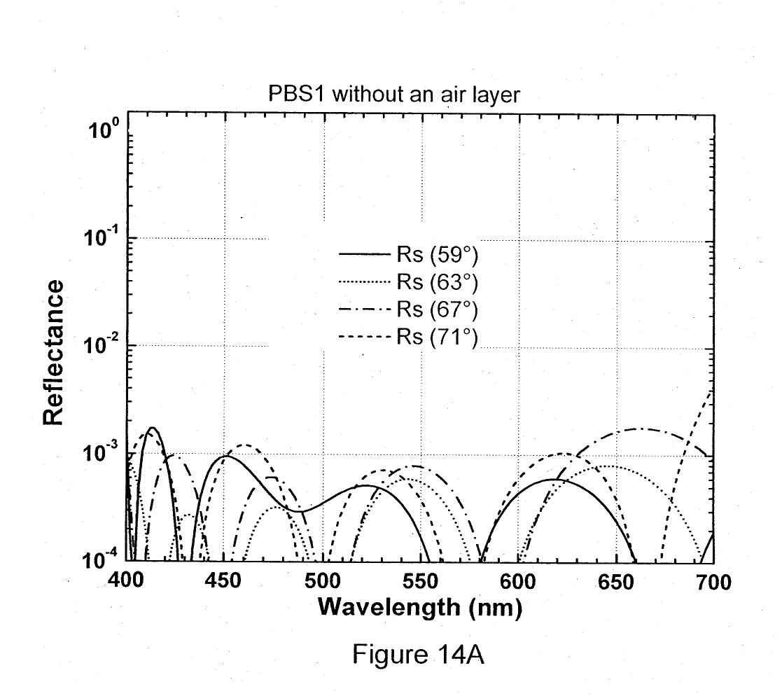

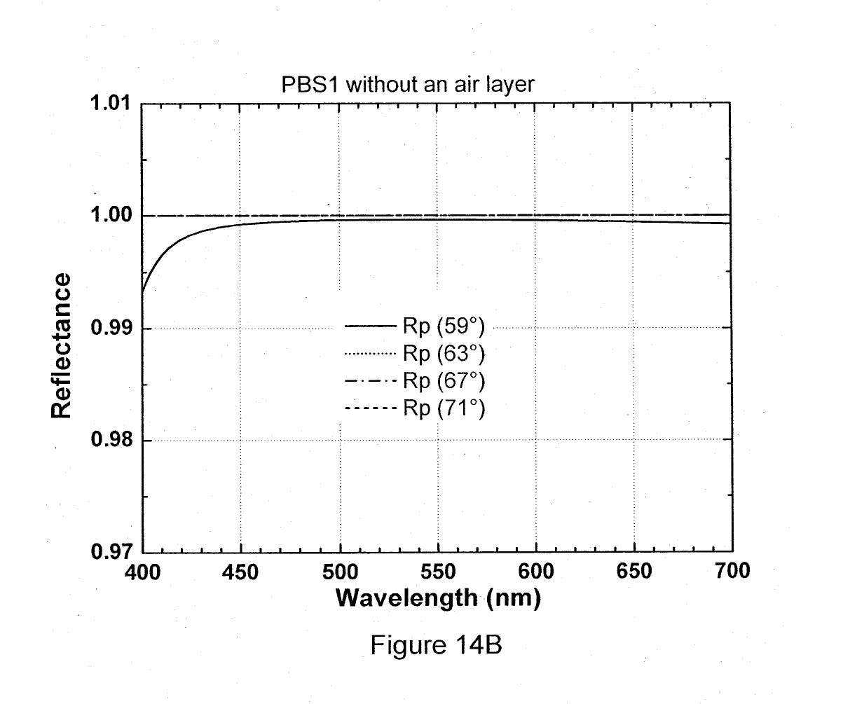

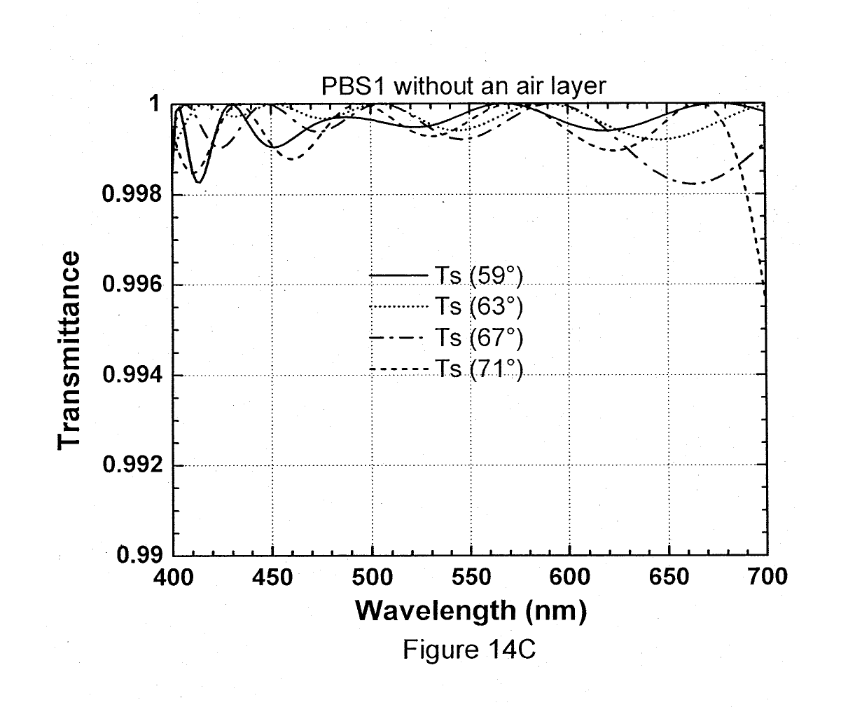

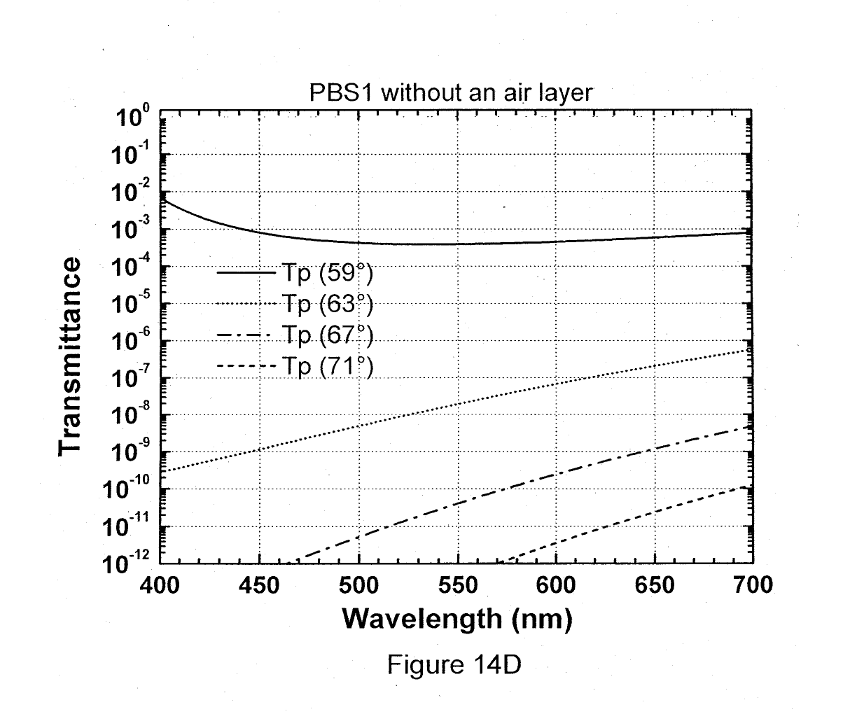

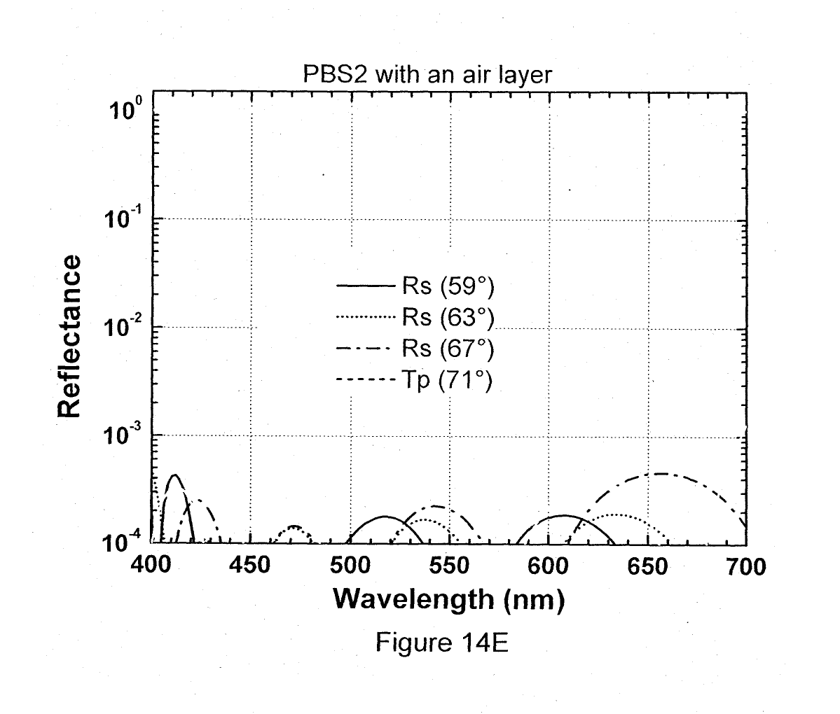

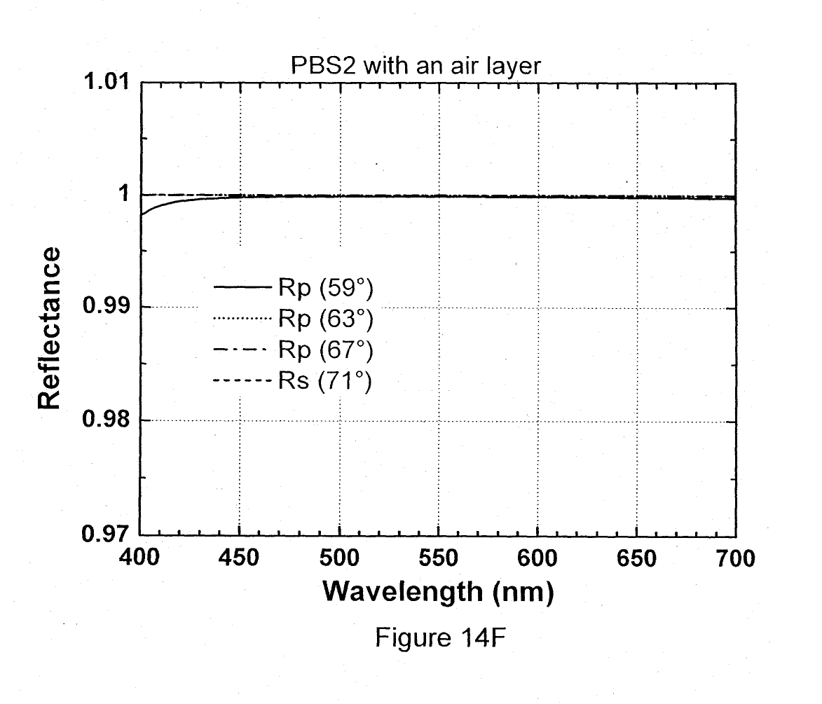

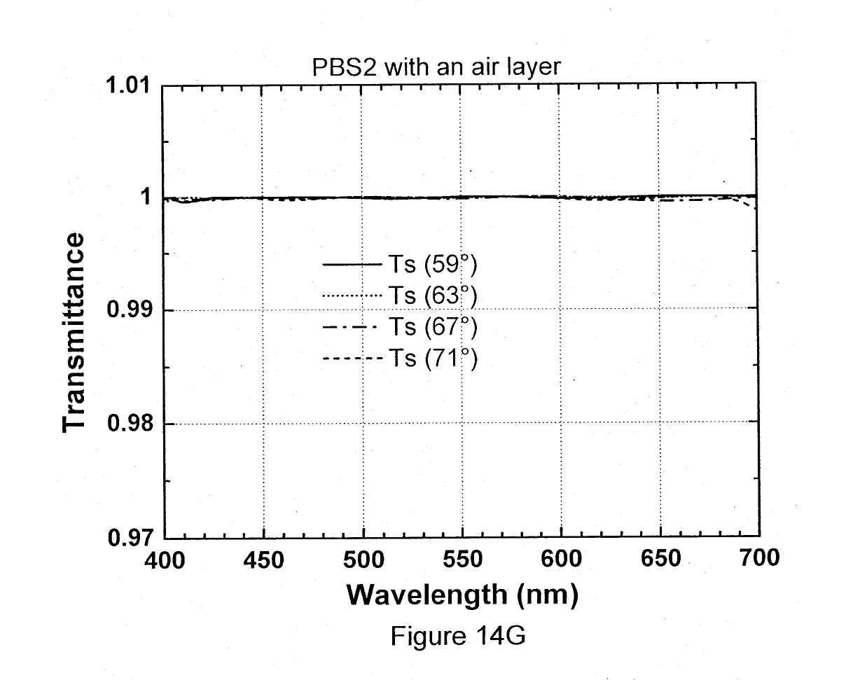

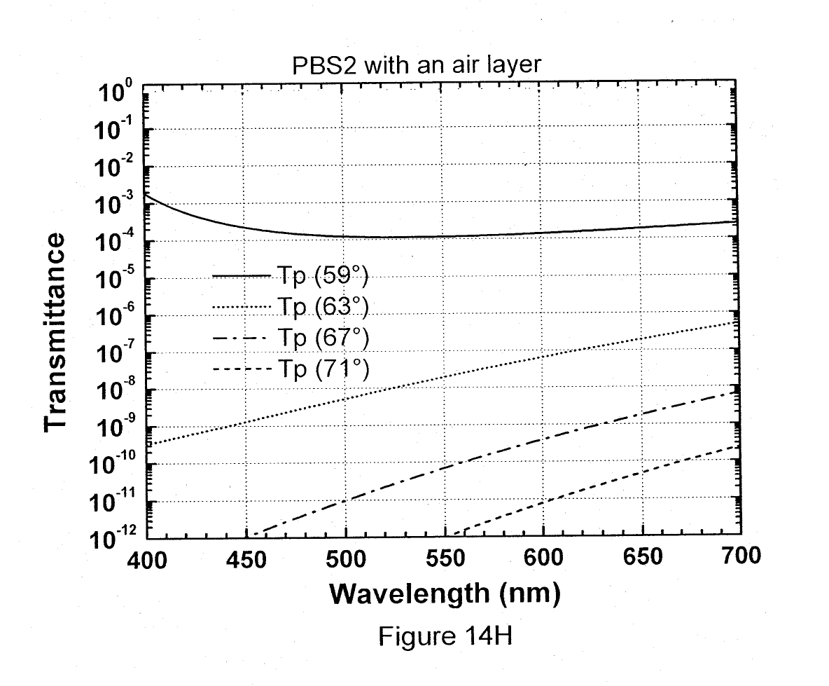

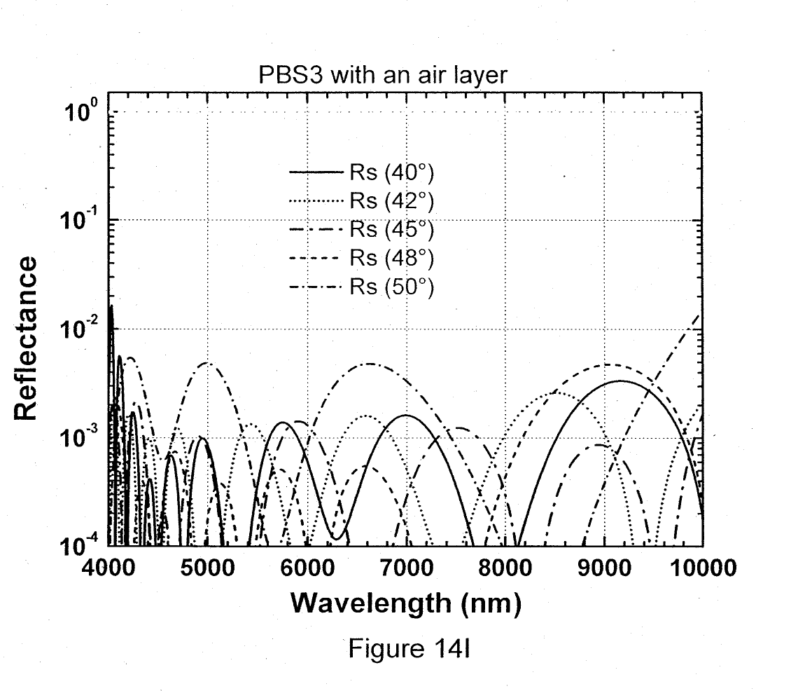

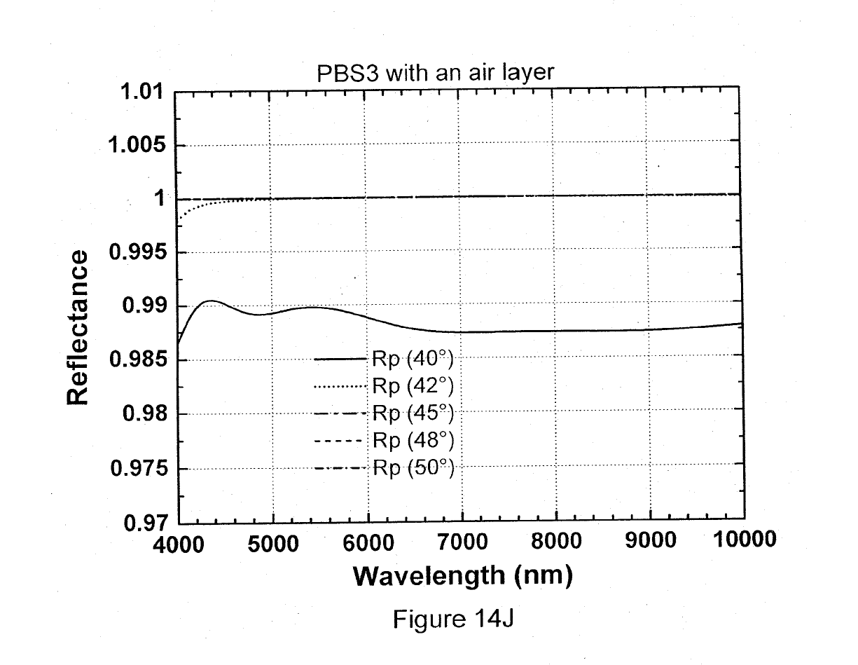

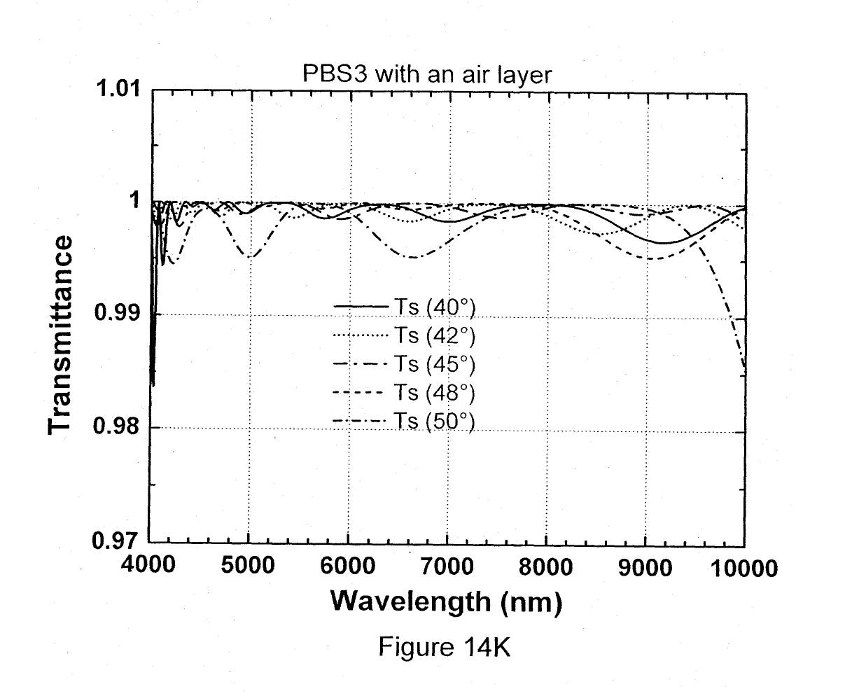

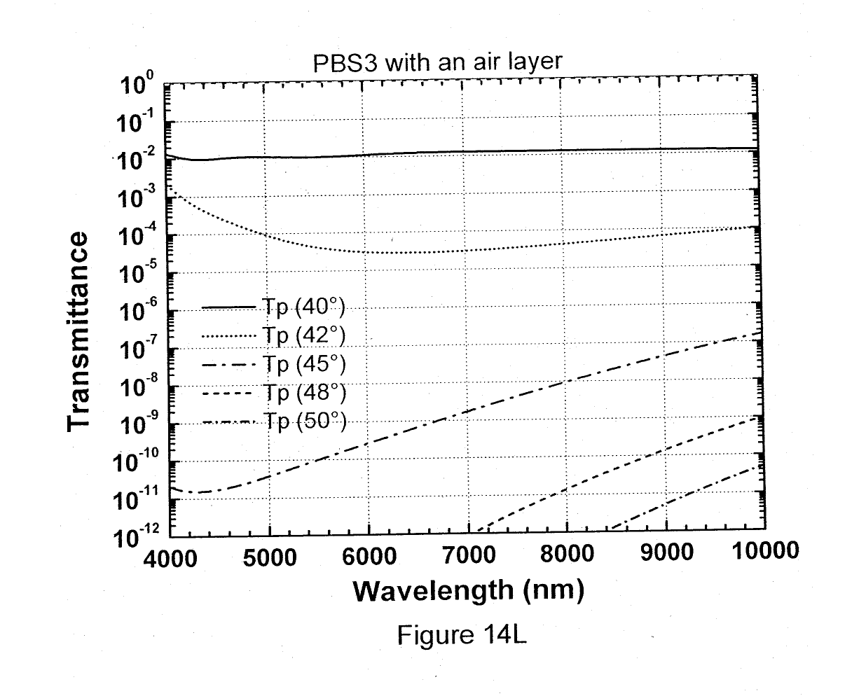

The first type of thin film optical filters that use an air layer in the coating in accordance with embodiments of the present invention is a polarizing beam-splitter (PBS) operating at angles greater than the critical angle. The performance of a PBS operating above the critical angle is determined by the refractive indices of the substrate and the high and low indices of the coating materials. The lower the refractive index of the low-index layers, the better the performance and the smaller the prism angle or the smaller the prism is. Unlike the thin film polarizing device disclosed in U.S. Pat. No. 5,912,762 that use all solid thin films, by incorporating one layer of air in a PBS coating with high and low solid index layers, the performance of such a PBS coating will improve significantly in the present invention. To demonstrate this, two PBS coatings, one without an air layer (PBS1) and one with an air layer (PBS2), were designed. The calculated reflectance and transmittance of s- and p-polarized light are shown in FIGS. 14A-14D for PBS1 and in FIGS. 14E-14H. Although, PBS1 and PBS2 are very similar and both have symmetrical structures, the performance of PBS2, with merit function of 0.017, is much better than that of PBS1 with a merit function of 0.066 for both transmitted and reflected beams. In addition, a polarizing beam-splitter prism substrates with the PBS2 coating will be much easier to be contacted or bonded because only the small area in the prism substrates defined by the spacer is needed to be contacted. To achieve a similar merit function as PBS1, other PBS coatings similar to PBS2 with an air layer can be designed to have fewer layers, or a smaller total layer thickness or reduced angles of incidence.

Another PBS coating, PBS3, similar to PBS2, was designed for the infrared region from 2 to 20 μm. The calculated reflectance and transmittance of s- and p-polarized light for PBS3 are shown in FIGS. 14I-14L. The use of an air layer in infrared coatings having reduced contact area defined by the spacer layer, including infrared PBSs, has several advantages compared to the use of optical glues or optical contacting in visible PBSs. First, it overcomes the problem that there are no suitable index matching optical glues for use in the infrared spectral region. Second, because infrared coatings are much thicker than visible coatings and are usually deposited by evaporation, the resulting coating surface quality, such as the roughness of the coatings, is much worse than that of coatings produced by high energy deposition processes such as sputtering for the visible spectrum. This surface quality deterioration increases with the increase of total layer thickness. As a result, it is much more difficult to bond evaporated thick infrared coatings in a large area by optical contact. Third, because the wavelength in the infrared is much longer than in the visible, the flatness of the substrates is of less concern. For example, at the wavelength λ=0.55 μm, 4 μm, and 10 μm, 20 μm departure from flatness is equivalent to 0.03636, 0.005 and 0.002 of a wavelength, relatively very small for the infrared wavelength at 20 μm. Fourth, the air layer reduces the total layer thickness required for infrared coating solutions compared to coatings without the air layer. This is very important for the infrared region because it greatly reduces the deposition time and thus the manufacturing cost of the coatings.

The layers systems such as thickness and refractive indices of PBS1, PBS2 and PBS3 are listed in Table 1.

TABLE 1
Layers systems of PBS1, PBS2 and PBS3

| | PBS1 | | PBS2 | | PBS3 | |
|---|---|---|---|---|---|---|
| | Index | Thickness | Index | Thickness | Index | Thickness |
| | nᵢ | dᵢ (nm) | nᵢ | dᵢ (nm) | nᵢ | dᵢ (nm) |
| Sub. | 1.85 | | 1.85 | | 2.40 | |
| Layers | 1.38 | 27.7 | 1.38 | 24.0 | 2.20 | 53.8 |
| | 2.35 | 34.3 | 2.35 | 31.3 | 4.00 | 439.1 |
| | 1.38 | 65.6 | 1.38 | 53.5 | 2.20 | 166.2 |
| | 2.35 | 36.6 | 2.35 | 29.3 | 4.00 | 400.3 |
| | 1.38 | 66.6 | 1.38 | 51.5 | 2.20 | 282.0 |
| | 2.35 | 38.4 | 2.35 | 36.1 | 4.00 | 371.0 |
| | 1.38 | 80.3 | 1.38 | 73.0 | 2.20 | 358.1 |
| | 2.35 | 40.3 | 2.35 | 39.4 | 4.00 | 355.4 |
| | 1.38 | 80.1 | 1.38 | 76.3 | 2.20 | 396.7 |
| | 2.35 | 37.9 | 2.35 | 40.4 | 4.00 | 347.5 |
| | 1.38 | 79.9 | 1.38 | 85.0 | 2.20 | 415.5 |
| | 2.35 | 39.2 | 2.35 | 42.2 | 4.00 | 343.7 |
| | 1.38 | 83.7 | 1.38 | 84.2 | 2.20 | 424.9 |
| | 2.35 | 38.1 | 2.35 | 43.0 | 4.00 | 343.0 |
| | 1.38 | 78.9 | 1.00 | 55.2 | 2.20 | 425.4 |
| | 2.35 | 38.1 | 2.35 | 43.0 | 4.00 | 379.1 |
| | 1.38 | 83.7 | 1.38 | 84.2 | 1.00 | 310.0 |
| | 2.35 | 39.2 | 2.35 | 42.2 | 4.00 | 379.1 |
| | 1.38 | 79.9 | 1.38 | 85.0 | 2.20 | 425.3 |
| | 2.35 | 37.9 | 2.35 | 40.4 | 4.00 | 343.0 |
| | 1.38 | 80.1 | 1.38 | 76.3 | 2.20 | 424.9 |
| | 2.35 | 40.3 | 2.35 | 39.4 | 4.00 | 343.7 |
| | 1.38 | 80.3 | 1.38 | 73.0 | 2.20 | 415.6 |
| | 2.35 | 38.4 | 2.35 | 36.1 | 4.00 | 347.4 |
| | 1.38 | 66.6 | 1.38 | 51.5 | 2.20 | 397.1 |
| | 2.35 | 36.6 | 2.35 | 29.3 | 4.00 | 355.2 |
| | 1.38 | 65.6 | 1.38 | 53.5 | 2.20 | 358.8 |
| | 2.35 | 34.3 | 2.35 | 31.3 | 4.00 | 370.8 |
| | 1.38 | 27.7 | 1.38 | 24.0 | 2.20 | 283.1 |
| | | | | | 4.00 | 399.8 |
| | | | | | 2.20 | 167.3 |
| | | | | | 4.00 | 443.0 |
| | | | | | 2.20 | 54.3 |
| Sub | 1.85 | | 1.85 | | 2.40 | |
| Σnᵢdᵢ | | 1576.4 | | 1473.5 | | 11320.2 |

The second type of thin film optical filters that uses an air layer in the coating in accordance with embodiments of the present invention is a non-polarizing beam-splitter (NPBS) operating at angles greater than the critical angle. Non-polarizing beam-splitters operating at oblique angles, for example at angle of incidence of 45° in a cube, are very difficult to design. At angle of incidence of 45°, the separation between s- and p-polarized light is much larger for thin film optical coatings having all solid film because this angle is close to the Brewster angle at which the separation between s- and p-polarized light is the largest. Although it is possible to design high performance narrow angular field NPBS based on frustrated total internal reflection as described by Li Li, such an NPBS has to operate at undesirably large angles of incidence which are close to and greater than the critical angle, much lager than 45°. With the use of only a single air layer with solid low and high index films, the angles of incidence can be greatly brought down to 45° for non-polarizing beam-splitters in the present invention.

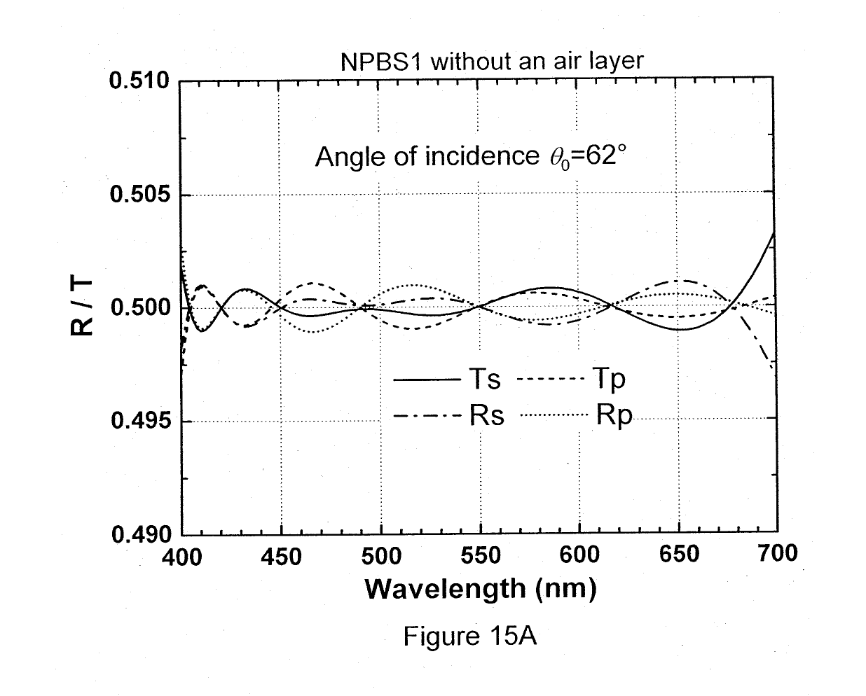

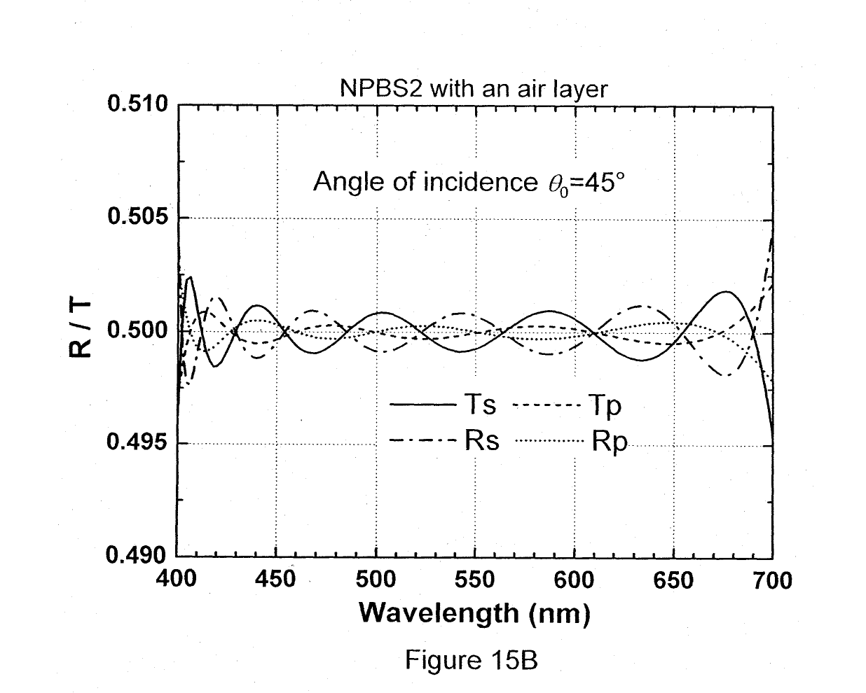

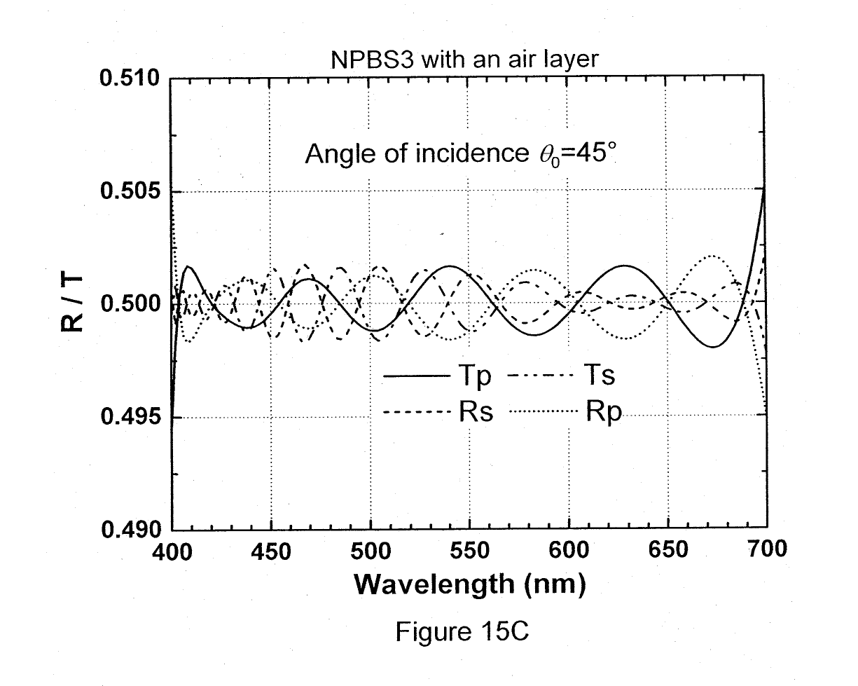

To demonstrate the effect of the air layer, a non-polarizing beam-splitter NPBS1 having all solid films was designed similar to that described by Li Li. It consists of low and high index layers with refractive indices 1.45 and 1.76 on substrates with a refractive index of 1.76. It operates at an angle of incidence of 62°; the angle is much larger than the desirable 45°. The calculated transmittance and reflectance of s- and p-polarized light for NPBS1 is shown in FIG. 15A and the layer system is listed in Table 2.

TABLE 2
Layers systems of NPBS1, NPBS2 and NPBS3

| | NPBS1 | | NPBS2 | | NPBS3 | |
|---|---|---|---|---|---|---|
| | Index | Thickness | Index | Thickness | Index | Thickness |
| | nᵢ | dᵢ (nm) | nᵢ | dᵢ (nm) | nᵢ | dᵢ (nm) |
| Sub. | 1.76 | | 1.76 | | 1.52 | |
| Layers | 1.45 | 9.6 | 1.45 | 26.9 | 1.45 | 27.6 |
| | 1.76 | 148.5 | 1.76 | 56.5 | 2.35 | 7.5 |
| | 1.45 | 39.4 | 1.45 | 117.8 | 1.45 | 90.8 |
| | 1.76 | 141.6 | 1.76 | 24.2 | 2.35 | 25.5 |
| | 1.45 | 75.7 | 1.45 | 132.7 | 1.45 | 41.4 |
| | 1.76 | 136.7 | 1.76 | 110.8 | 2.35 | 76.2 |
| | 1.45 | 93.2 | 1.45 | 14.9 | 1.45 | 19.9 |
| | 1.76 | 137.8 | 1.76 | 72.6 | 2.35 | 37.6 |
| | 1.45 | 67.9 | 1.45 | 174.2 | 1.45 | 318.0 |
| | 1.76 | 387.5 | 1.76 | 102.6 | 2.35 | 36.1 |
| | 1.45 | 151.3 | 1.45 | 175.3 | 1.45 | 48.8 |
| | 1.76 | 122.4 | 1.76 | 12.0 | 2.35 | 33.0 |
| | 1.45 | 24.3 | 1.00 | 91.9 | 1.45 | 164.0 |
| | | | 1.76 | 60.7 | 2.35 | 10.6 |
| | | | 1.45 | 155.5 | 1.00 | 139.6 |
| | | | 1.76 | 97.1 | 2.35 | 21.2 |
| | | | 1.45 | 104.5 | 1.45 | 135.4 |
| | | | 1.76 | 30.1 | 2.35 | 21.9 |
| | | | 1.45 | 180.4 | 1.45 | 47.6 |
| | | | 1.76 | 46.2 | 2.35 | 49.0 |
| | | | 1.45 | 40.6 | 1.45 | 125.1 |
| | | | 1.76 | 206.1 | 2.35 | 16.6 |
| | | | 1.45 | 8.6 | 1.45 | 23.7 |
| | | | 1.76 | 93.5 | 2.35 | 99.8 |
| | | | 1.45 | 6.4 | 1.45 | 139.9 |
| | | | | | 2.35 | 18.4 |
| | | | | | 1.45 | 64.4 |
| | | | | | 2.35 | 67.0 |
| | | | | | 1.45 | 54.1 |
| | | | | | 2.35 | 22.7 |
| | | | | | 1.45 | 153.1 |
| | | | | | 2.35 | 3.0 |
| | | | | | 1.45 | 162.4 |
| | | | | | 2.35 | 2.0 |
| Sub | 1.76 | | 1.76 | | 1.52 | |
| Σnᵢdᵢ | | 1535.8 | | 2142.0 | | 2303.9 |

The non-polarizing beam-splitter NPBS2 based on the present invention has a single air layer with traditionally solid high and low index. The air layer reduces the critical angle significantly from 55.5° in NPBS1 to 34.6° in NPBS2; as a result, the operating angle has been reduced from 62° in NPBS1 to 45° in NPBS2. The calculated transmittance and reflectance of s- and p-polarized light for NPBS2 is shown in FIG. 15B and the layer system is listed in Table 2. Although NPBS1 and NPBS2 have similar layer structures and similar performance in terms of flat transmittance over the 400-700 nm spectral region, NPBS2 is much easier to make and more practical to use because of reduced optical contacting area, smaller angles of incidence and smaller prism sizes. To keep the same angles of incidence as NPBS1, other NPBS coatings similar to NPBS2 with an air layer can be designed to have fewer layers, or a smaller total layer thickness or reduced angles of incidence, or better performance.

Non-polarizing beam-splitter coatings having integral air layer using low refractive index prism substrates such as BK7 with a refractive index of 1.52 for which optical glues are available, can also be designed. Without an air layer, it would have been not possible to design non-polarizing beam-splitter with all solid films by using both FTIR and interference effects because the very large critical angle. The non-polarizing beam-splitter NPBS3 is based on the principle of the present invention, the high index prism substrates in the above coating NPBS2 having a refractive index 1.76 is replaced by BK7 prisms having a refractive index 1.52; and high index layers with a refractive index 1.76 are replaced by layers with a refractive index of 2.35 such as TiO₂ or ZnS. BK7 from Schott or equivalent optical glasses from other suppliers is inexpensive optical glass that has very good optical properties and it is commonly used in lenses, windows and prisms. The calculated transmittance and reflectance of s- and p-polarized light for NPBS3 is shown in FIG. 15C and the layer system is listed in Table 2. Clearly, NPBS3 has a very good performance similar to NPBS1 and NPBS2. NPBS3 should cost less to manufacture because of the use of less expensive and low index substrates BK7 or equivalent optical glasses.

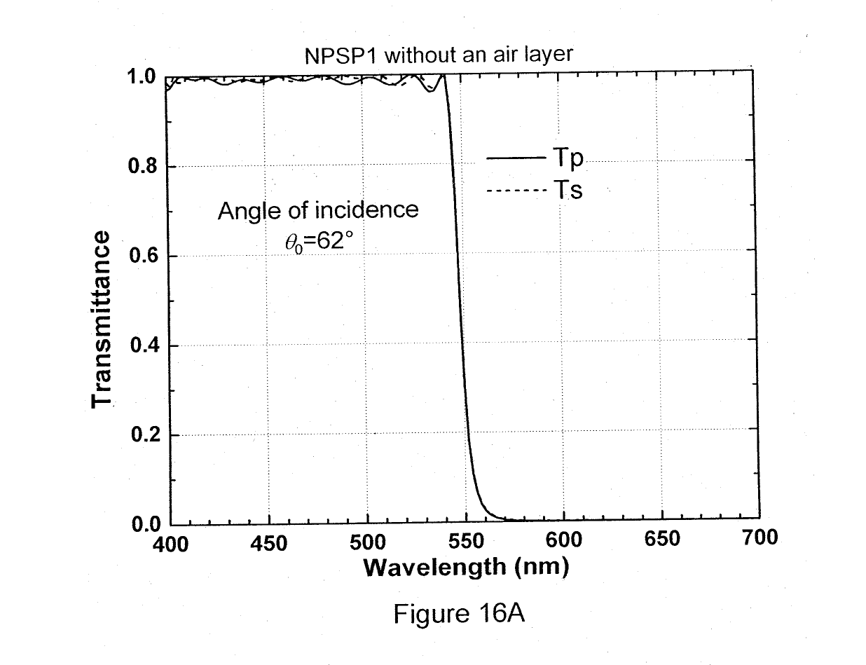

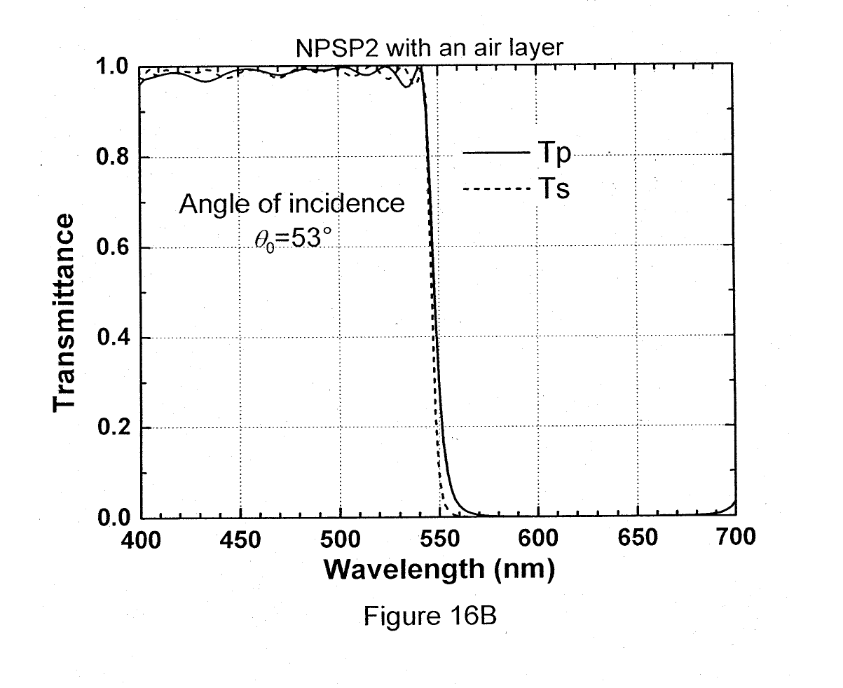

The third type of thin film optical filters that use an air layer in the coating in accordance with embodiments of the present invention is a non-polarizing shortwave pass filter operating at angles greater than the critical angle. Non-polarizing shortwave or longwave pass filters operating at oblique angles are also difficult to design for the same reason as non-polarizing beam-splitters. However, it is possible to design these non-polarizing filters in the present invention based on frustrated total internal reflection and interference having a single air layer and traditional high and low index solid films. The non-polarizing short wavelength pass filter NPSP1 is based on all solid films, NPSP2 is based on a single air layer plus additional high and low index solid films in accordance with the present invention. The calculated performance for NPSP1 and NPSP2 are shown in FIGS. 16A and 16B, respectively. The layer systems of NPSP1 and NPSP2 are listed in Table 3. Clearly, the performance of NPSP2 is not far off that of NPSP1, even though the incident angle has been reduced significantly from 62° to 53°. NPSP2 is easier to manufacture and to use. Using the same principle, non-polarizing longwave pass filters with an air layer can also be designed.

TABLE 3
Layers systems of NPSP1 and NPSP2

| | |
|---|---|
| NPSP1 | NPSP2 |

| | | Thickness | | Thickness |
|---|---|---|---|---|
| | Index nᵢ | dᵢ (nm) | Index nᵢ | dᵢ (nm) |
| Sub. | 1.75 | | 1.75 | |
| Layers | 2.35 | 23.2 | 1.45 | 165.3 |
| | 1.45 | 53.3 | 1.75 | 14.8 |
| | 2.35 | 172.4 | 1.45 | 335.2 |
| | 1.45 | 76.9 | 1.75 | 103.9 |
| | 2.35 | 39.8 | 1.45 | 115.2 |
| | 1.45 | 58.8 | 1.75 | 26.5 |
| | 2.35 | 142.8 | 1.45 | 380.7 |
| | 1.45 | 56.2 | 1.75 | 88.5 |
| | 2.35 | 38.6 | 1.45 | 120.8 |
| | 1.45 | 90.1 | 1.75 | 42.8 |
| | 2.35 | 168.6 | 1.45 | 175.7 |
| | 1.45 | 72.9 | 1.75 | 198.1 |
| | 2.35 | 167.3 | 1.45 | 204.2 |
| | 1.45 | 78.5 | 1.75 | 45.9 |
| | 2.35 | 161.5 | 1.45 | 111.4 |
| | 1.45 | 94.3 | 1.75 | 80.5 |
| | 2.35 | 9.9 | 1.45 | 425.6 |
| | 1.45 | 34.1 | 1.75 | 52.4 |
| | 2.35 | 22.9 | 1.45 | 79.4 |
| | 1.45 | 79.8 | 1.75 | 78.2 |
| | 2.35 | 28.5 | 1.45 | 306.3 |
| | 1.45 | 102.6 | 1.75 | 232.0 |
| | 2.35 | 34.0 | 1.45 | 209.5 |
| | 1.45 | 126.9 | 1.75 | 123.5 |
| | 2.35 | 161.5 | 1.00 | 30.0 |
| | 1.45 | 88.9 | 1.75 | 78.6 |
| | 2.35 | 161.6 | 1.45 | 292.4 |
| | 1.45 | 120.5 | 1.75 | 95.7 |
| | 2.35 | 30.7 | 1.45 | 112.4 |
| | 1.45 | 79.9 | 1.75 | 42.7 |
| | 2.35 | 22.3 | 1.45 | 263.9 |
| | 1.45 | 64.7 | 1.75 | 118.8 |
| | 2.35 | 19.2 | 1.45 | 113.0 |
| | 1.45 | 60.4 | 1.75 | 35.9 |
| | 2.35 | 25.9 | 1.45 | 265.9 |
| | 1.45 | 106.2 | 1.75 | 107.6 |
| | 2.35 | 156.8 | 1.45 | 111.4 |
| | 1.45 | 44.6 | 1.75 | 30.3 |
| | 2.35 | 24.9 | 1.45 | 275.5 |
| | 1.45 | 30.5 | 1.75 | 68.2 |
| | 2.35 | 284.4 | 1.45 | 50.9 |
| | 1.45 | 46.0 | 1.75 | 75.0 |
| | 2.35 | 42.8 | 1.45 | 295.2 |
| | 1.45 | 34.3 | 1.75 | 42.2 |
| | 2.35 | 161.6 | 1.45 | 84.8 |
| | 1.45 | 34.4 | 1.75 | 110.7 |
| | 2.35 | 28.1 | 1.45 | 274.6 |
| | | | 1.75 | 22.3 |
| | | | 1.45 | 153.5 |
| Sub | 1.75 | | 1.75 | |
| Σnᵢdᵢ | | 3764.4 | | 6868.1 |

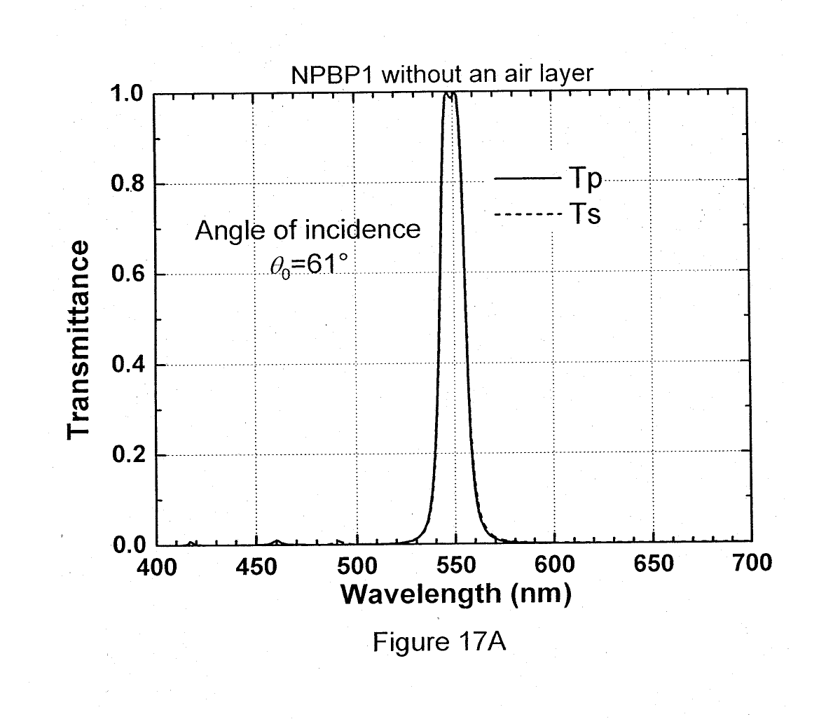

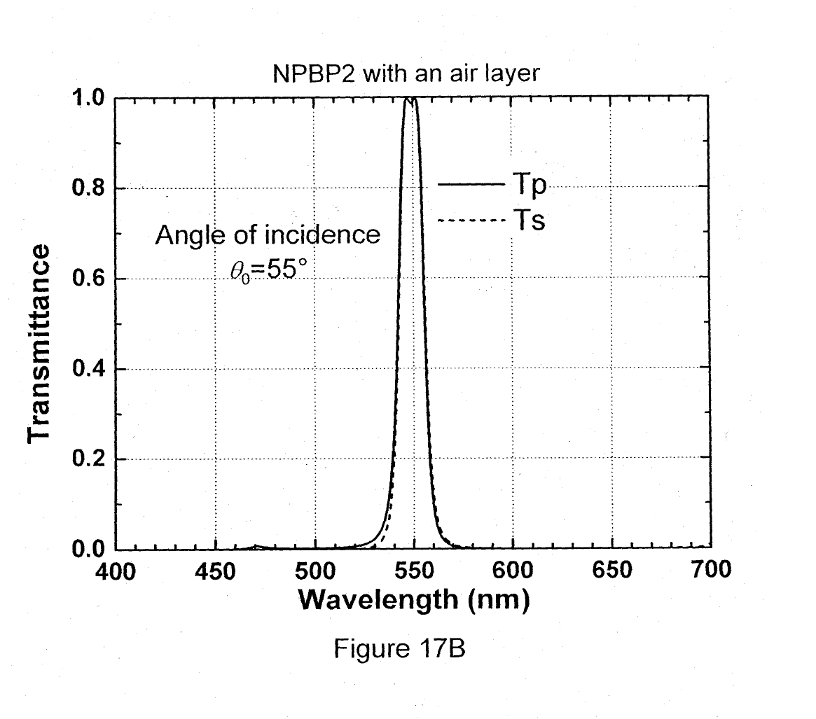

The fourth type of thin film optical filters that use an air layer in the coating in accordance with embodiments of the present invention is a non-polarizing bandpass filter operating at angles greater than the critical angle. Example NPBP1 is a non-polarizing bandpass filter based on all solid films. It operates at 61°. Example NPBP2 is a non-polarizing bandpass filter similar to NPBP1 but has with an air layer according to the present invention. The calculated performance for NPSP1 and NPBP2 are shown in FIGS. 17A and 17B, respectively. The layer systems are listed in Table 4. Clearly, the performance of NPBP2 is not far off that of NPSP1, even though the incident angle has been reduced from 61° to 55°. And again, this makes the NPBP2 filter easier to manufacture and to use.

TABLE 4
Layers systems of NPBP1 and NPBP2

| | |
|---|---|
| NPBP1 | NPBP2 |

| | | Thickness | | Thickness |
|---|---|---|---|---|
| | Index nᵢ | dᵢ (nm) | Index nᵢ | dᵢ (nm) |
| Sub. | 1.75 | | 1.75 | |
| Layers | 1.45 | 236.2 | 1.45 | 444.9 |
| | 1.75 | 394.2 | 1.75 | 27.5 |
| | 1.45 | 178.9 | 1.45 | 312.6 |
| | 1.75 | 101.8 | 1.75 | 125.1 |
| | 1.45 | 227.7 | 1.45 | 663.2 |
| | 1.75 | 65.3 | 1.75 | 195.8 |
| | 1.45 | 69.3 | 1.45 | 1083.5 |
| | 1.75 | 60.2 | 1.75 | 11.7 |
| | 1.45 | 148.2 | 1.00 | 194.3 |
| | 1.75 | 91.2 | 1.75 | 84.8 |
| | 1.45 | 610.2 | 1.45 | 583.4 |
| | 1.75 | 110.1 | 1.75 | 18.1 |
| | 1.45 | 303.7 | 1.45 | 226.2 |
| | 1.75 | 67.2 | 1.75 | 113.6 |
| | 1.45 | 25.1 | 1.45 | 386.8 |
| | 1.75 | 69.1 | 1.75 | 52.9 |
| | 1.45 | 279.1 | 1.45 | 240.3 |
| | 1.75 | 108.4 | 1.75 | 82.5 |
| | 1.45 | 312.8 | 1.45 | 534.7 |
| Sub | 1.75 | | 1.75 | |
| Σnᵢdᵢ | | 3458.6 | | 5382.0 |

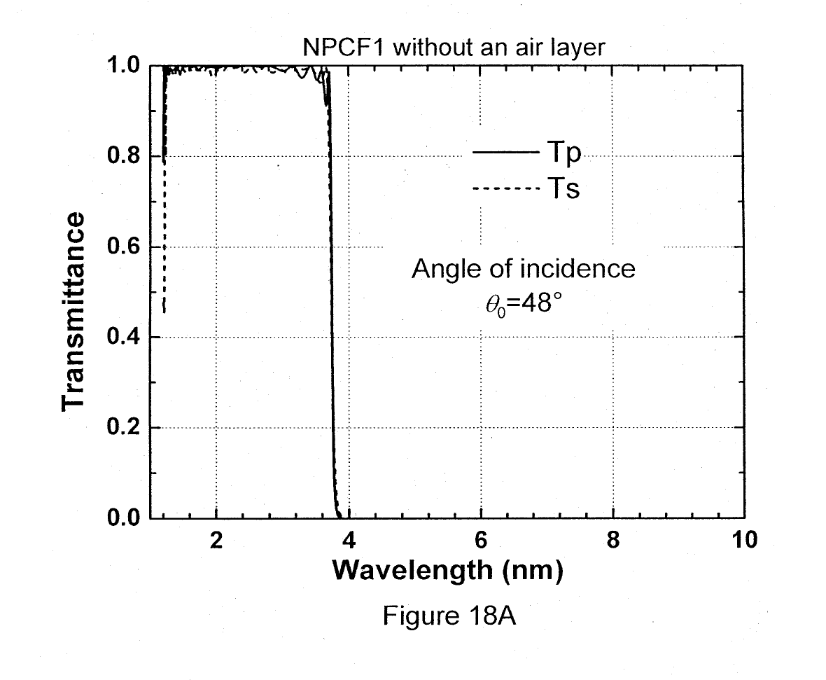

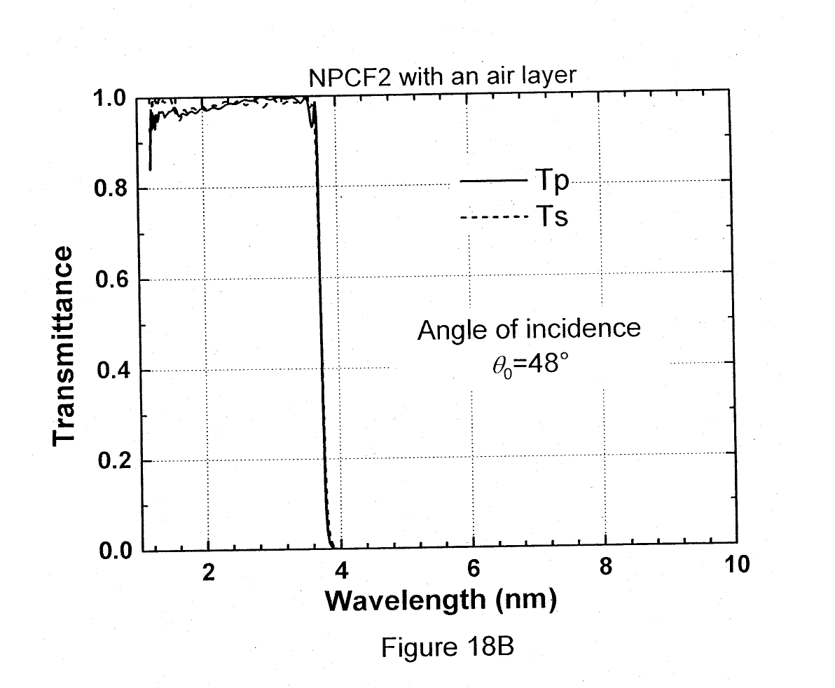

The fifth type of thin film optical filters that use an air layer in the coating in accordance with embodiments of the present invention is a non-polarizing long wavelength cut-off filter based on frustrated total internal reflection, interference as well as refractive index dispersion with the use of Reststrahlen materials. The non-polarizing cut-off filter NPCF1 is based on all solid films as described in the J. A. Dobrowolski and Li Li paper. The non-polarizing cut-off filter NPCF2 is based on the principle of the present invention having a single air layer as well as solid films. The calculated performance of NPCF1 and NPCF2 are shown in FIGS. 18A and 18B, respectively. The optical constants of MGO and ZnS are taken from the book “Handbook of Optical Constants of Solids”, edited by Palik. The layer systems are listed in Table 5. Clearly, NPCF2 has a performance similar to that of NPCF1. Although the use of an air layer in this case does not improve the performance of the coating, it allows the filter to be manufactured more easily. In addition, the air layer can have a thin fixed thickness.

TABLE 5
Layers systems of NPCF1 and NPCF2

| | |
|---|---|
| NPCF1 | NPCF2 |

| | | Thickness | | Thickness |
|---|---|---|---|---|
| | Material | dᵢ (nm) | Material | dᵢ (nm) |
| Sub. | ZnS | | ZnS | |
| Layers | MgO | 118.5 | MgO | 63.7 |
| | ZnS | 188.0 | ZnS | 219.1 |
| | MgO | 318.9 | MgO | 203.2 |
| | ZnS | 116.9 | ZnS | 154.3 |
| | MgO | 590.9 | MgO | 400.1 |
| | ZnS | 66.7 | ZnS | 99.5 |
| | MgO | 954.6 | MgO | 662.9 |
| | ZnS | 37.0 | ZnS | 62.0 |
| | MgO | 1334.6 | MgO | 1016.2 |
| | ZnS | 17.6 | ZnS | 35.9 |
| | MgO | 1642.4 | MgO | 1378.6 |
| | ZnS | 9.0 | ZnS | 19.6 |
| | MgO | 3699.5 | MgO | 1634.0 |
| | ZnS | 1.5 | ZnS | 9.6 |
| | MgO | 2279.9 | MgO | 1817.3 |
| | MgO | 1847.0 | ZnS | 3.1 |
| | ZnS | 0.0 | MgO | 11997.0 |
| | MgO | 9738.0 | ZnS | 1.4 |
| | ZnS | 7.3 | MgO | 2362.2 |
| | MgO | 1813.1 | ZnS | 5.6 |
| | ZnS | 14.5 | MgO | 1766.2 |
| | MgO | 1554.9 | ZnS | 15.6 |
| | ZnS | 27.0 | MgO | 1342.9 |
| | MgO | 1249.8 | ZnS | 28.5 |
| | ZnS | 49.2 | MgO | 864.9 |
| | MgO | 826.4 | ZnS | 46.5 |
| | ZnS | 82.9 | MgO | 574.6 |
| | MgO | 515.1 | ZnS | 75.1 |
| | ZnS | 132.5 | MgO | 401.2 |
| | MgO | 283.1 | ZnS | 152.2 |
| | ZnS | 191.0 | MgO | 100.1 |
| | MgO | 107.9 | air | 30.0 |
| | | | ZnS | 258.2 |
| | | | MgO | 77.7 |
| | | | ZnS | 322.0 |
| | | | MgO | 12.9 |
| Sub | ZnS | | ZnS | |
| Σnᵢdᵢ | | 29815.4 | | 28213.7 |

In all the above filters, the coated substrates can also be brought together and held against each other by mechanical means. There will be an air gap between the two substrates with a variable thickness that will depend on the flatness of the substrates. The coatings can be designed for an average air gap thickness.

Without departing from the spirit of the present invention, many other types of thin film optical filters that operate at oblique angles of incidences with well controlled polarization properties can be designed to consist of solid films as well as a single air layer. In most cases, either the performance of the thin film optical filters will be improved, or the prism size can be reduced because the angles of incidence can be reduced with the use of low index air layer, or the total number of layer's or layer thickness is reduced, or all of the above. In addition, the use of an air layer significantly reduces the difficulty of optical contacting or bonding due to the reduced area for contacting, thus making the coatings easier to manufacture and cost less.

1. An optical device comprising:
a pair of transparent substrate prisms having opposing faces bonded together at an interface;
a thin film interference structure between said pair of transparent substrate prisms; and
a spacer layer located between said opposing faces, said spacer layer separating said transparent substrates to form a cavity containing low refractive index layer comprising a non-reactive gas or vacuum; and
wherein said low refractive index layer in said cavity acts as an interference layer forming an integral part of said thin film structure, and
wherein said thin film structure is operable to permit thin film interference coupled with frustrated total internal reflection inside said low index layer at certain angles of incidence.

2. An optical device as claimed in claim 1, wherein said thin film interference structure includes a plurality of thin film coatings on at least one of said opposing faces.

3. An optical device of claim 1, wherein said cavity contains air.

4. An optical device as claimed in claim 1, wherein said spacer layer is in the form of a frame deposited on at least one of said transparent substrates and surrounding the cavity layer.

5. An optical device as claimed in claim 4, wherein said frame extends around the edges of said opposing faces.

6. An optical device of claim 4, wherein transversal slits are formed in sides of said frame.

7. An optical device as claimed in claim 2, wherein at least one said thin film coating is provided on each of said opposing faces, and said spacer layer is provided between the thin film coatings on the respective opposing faces.

8. An optical device as claimed in claim 1, wherein said transparent substrate prisms have non-working end faces lying in a common planes, and a cover plate is bonded to pairs of said non-working end faces in each common plane.

9. An optical device as claimed in claim 8, wherein each said cover plate is made of the same material as said transparent substrates.

10. An optical device as claimed in claim 1, wherein said spacer layer is made from the same material as a solid layer of said thin film structure.

11. An optical device as claimed in claim 1, wherein said spacer layer is made from a precisely cleaved mica film.

12. An optical device as claimed in claim 1, wherein said spacer layer is made of a material selected from the group consisting of: ZNS, Ge, Si, MgO, SiO₂, TiO₂, Ta₂O₅, Nb₂O₅, and Al₂O₃.

13. An optical device as claimed in claim 1, wherein said spacer layer is optically flat to provide an optical contact between said spacer layer and one of said transparent substrates in order to join said transparent substrates together.

14. An optical device as claimed in claim 1, wherein said optical device is selected from the group consisting of: a polarizing beam splitter, a non-polarizing beam splitter,
non-polarizing long wavelength cut-off filter, a non-polarizing bandpass filter, a non-polarizing shortwave pass filter and a non-polarizing longwave pass filter.

15. A method of making an optical device comprising:
providing a pair of transparent substrate prisms having opposing faces;
forming a thin film interference structure between said pair of transparent substrates configured to subject light incident on one of said substrates at certain angles of incidence to thin film interference coupled with frustrated total internal reflection; and
bonding opposing faces together through a spacer layer, said spacer layer separating said transparent substrates to form a low refractive index cavity layer that acts as an interference layer forming an integral part of said thin film interference structure.

16. A method as claimed in claim 15, wherein said spacer layer comprises at least a film applied to said faces to form said cavity therein.

17. A method as claimed in claim 15, wherein said spacer layer is in the form of a frame surrounding said cavity.

18. A method as claimed in claim 17, wherein said frame extends around the edges of said opposing faces.

19. A method as claimed in claim 18, wherein said frame is rectangular with transverse slits formed in the edges thereof.

20. A method as claimed in claim 15, wherein the bonded transparent prisms have non-working end faces lying in respective common planes, and respective cover plates are bonded to said non-working end faces in said respective common planes.

21. A method as claimed in claim 20, wherein said cover plates are made of the same material as said transparent substrate prisms.

22. A method as claimed in claim 15, wherein said transparent substrate prisms are joined together by means of an optical contact between said spacer layer formed on one said opposing face and the other said opposing face.

23. A method as claimed in claim 22, wherein a bead of epoxy is applied to an exposed edge of said optical contact.

24. A method as claimed in claim 15, wherein said cavity layer is air.

25. A method as claimed in claim 15, wherein said thin film structure is formed by depositing a plurality of said thin film coatings on said at least one of said transparent faces.
